(19) United States
(12) Patent Application Publication
(10) Pub. No.: US 2025/0371924 A1
(43) Pub. Date: Dec. 4, 2025

(54) MONEY HANDLING APPARATUS AND MONEY HANDLING METHOD

(71) Applicant: Glory Ltd., Himeji-shi (JP)

(72) Inventors: Tasuku NAKAMOTO, Himeji-shi (JP); Keiju NAKAGAWA, Himeji-shi (JP); Kouichi NABEYAMA, Himeji-shi (JP); Hiroshi DANJO, Himeji-shi (JP); Satoru KOBAYASHI, Himeji-shi (JP); Mohammad Nurul ISLAM, Himeji-shi (JP)

(73) Assignee: Glory Ltd., Himeji-shi (JP)

(21) Appl. No.: 19/305,836

(22) Filed: Aug. 21, 2025

Related U.S. Application Data
(63) Continuation of application No. PCT/JP2024/006721, filed on Feb. 26, 2024.

(30) Foreign Application Priority Data
Mar. 1, 2023 (JP) 2023-031244

(51) Int. Cl. G07D 11/25; G07D 11/34

(52) U.S. Cl. CPC G07D 11/25; G07D 11/34; G07D 2201/00; G07D 2211/00

(57) ABSTRACT

To improve efficiency of a dispensing process, a money handling method for an apparatus that feeds out money from storage units including a first storage unit storing denominations of money in a mixed state, and dispenses the money, include: performing a dispensing process for dispensing money corresponding to a dispensing amount to be dispensed; recording a dispensing history including information on the denominations and the quantity for each denomination of the money dispensed in the dispensing process; changing, based on the dispensing history, a denomination assignment to assign a first denomination assigned to the first storage unit to another storage unit among the storage units; and performing a replacement process for transferring money of the first denomination from the first storage unit to the other storage unit, for which the assigned denominations are changed.

### CROSS-REFERENCE TO RELATED APPLICATIONS

The present application is a bypass continuation of, and claims priority to, International application PCT/JP2024/006721, filed Feb. 26, 2024, the entire contents of which is incorporated herein by reference. PCT/JP2024/006721 claims priority to JP2023-031244, filed Mar. 1, 2023, the entire contents of which is incorporated herein by reference.

### TECHNICAL FIELD

The present disclosure relates to a money handling apparatus including a plurality of money storage units, and a money handling method for the money handing apparatus.

### BACKGROUND ART

Conventionally, various types of money handling apparatuses have been used. In stores, a money handling apparatus is used for transactions with customers to perform a deposit process for receiving money paid by the customer and storing the money in the apparatus, and a dispensing process for returning change to the customer by discharging the change from the apparatus.

A compact money handling apparatus may be required depending on the size of a store. There is a money handling apparatus whose size is reduced by decreasing the number of storage units for storing coins inside the apparatus. In this apparatus, two denominations are assigned to each of three storage units, so that all six denominations of coins included in Japanese currency can be stored in the apparatus. When this apparatus performs a process of dispensing change to be returned to a customer, since each storage unit stores two denominations of coins therein, the change cannot be dispensed in the same way as a case where target coins can be fed out from each storage unit storing a single denomination.

### SUMMARY

The present disclosure has been made in view of the problem, as well as other problems, of the conventional art, and the present disclosure addresses these issues, as discussed herein, with a money handling apparatus and a money handling method capable of efficiently performing a dispensing process even when money is stored in a mixed state in a storage unit provided inside the apparatus.

A money handling method according to one aspect of the present disclosure is a method for a money handling apparatus configured to feed out money from a plurality of storage units including a first storage unit storing a plurality of denominations of money in a mixed state, and dispenses the money. The method includes: performing a dispensing process for dispensing money of denominations and the quantity for each denomination corresponding to an amount to be dispensed; recording a dispensing history including information on the denominations and the quantity for each denomination of the money, corresponding to the amount to be dispensed, dispensed in the dispensing process; changing, based on the dispensing history, a denomination assignment to assign a first denomination included in the plurality of denominations assigned to the first storage unit, to another storage unit different from the first storage unit, among the plurality of storage units; and performing a replacement process for transferring money of the first denomination from the first storage unit to the other storage unit, for which the assigned denominations are changed.

### BRIEF DESCRIPTION OF THE DRAWINGS

FIG. 1 illustrates an outline of a money handling apparatus and money handling performed by the money handling apparatus.

FIGS. 2A and 2B illustrate an outline of a coin handling apparatus.

FIGS. 3A and 3B are schematic cross-sectional views illustrating an example of a specific configuration of the coin handling apparatus.

FIG. 4 is a flowchart showing an example of a process flow that the coin handling apparatus performs in a dispensing process.

FIGS. 5A and 5B each illustrates a substitute dispensing condition.

FIG. 6 illustrates a denomination change condition based on recognition order.

FIGS. 7A and 7B illustrate an example of temporary storage and dispensing of coins.

FIG. 8 illustrates an example of a dispensing history.

FIG. 9 illustrates an example of a process of changing storage unit setting.

FIGS. 10A to 10D illustrate an example of a replacement process performed by the coin handling apparatus.

FIGS. 11A to 11C illustrate another example of changing storage unit setting.

FIG. 12 illustrates still another example of changing storage unit setting.

FIG. 13 is a flowchart illustrating yet another example of changing storage unit setting.

### DESCRIPTION OF EMBODIMENT

Hereinafter, an embodiment of a money handling apparatus and a money handling method according to the present disclosure will be described with reference to the accompanying drawings. The money handling apparatus according to the present disclosure can store money received from outside the apparatus into storage units, each of which is assigned one or more denominations of money, based on the denomination of the money and the denomination assigned to each storage unit. The money handling apparatus can perform a dispensing process in which money to be dispensed is fed out from a storage unit and discharged to outside the apparatus. If money to be dispensed needs to be fed out from a storage unit where a plurality of denominations of money are stored in a mixed state, the money handling apparatus can change the dispensing method, based on a mixing ratio of money stored in a storage unit in the mixed state, the number of pieces of money that has been fed out since the start of money feeding from the storage unit, an elapsed time from the start of the money feeding, etc. In addition, the money handling apparatus can change denomination assignment to each storage unit to improve handling efficiency, based on history information on dispensing processes performed in the past, and exchange money between a plurality of storage units based on the changed denomination assignment.

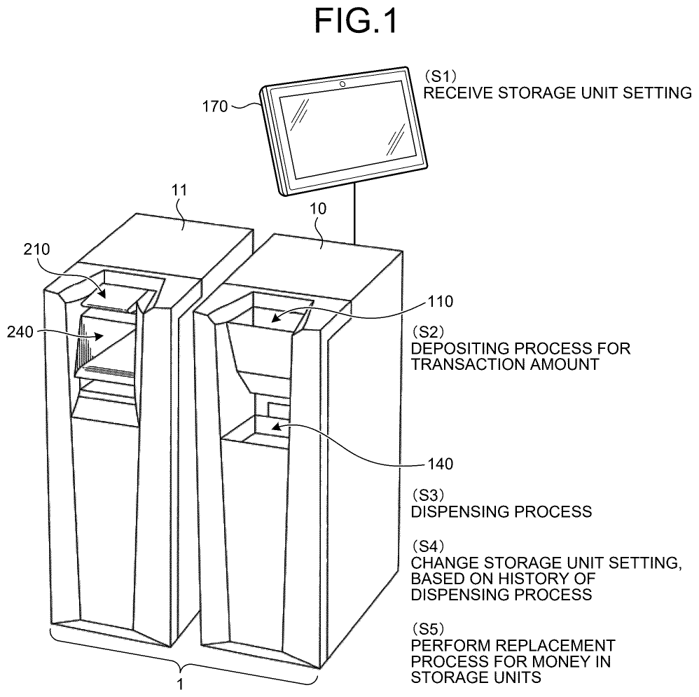

FIG. 1 illustrates an outline of a money handling apparatus 1 and money handling performed by the money handling apparatus 1, according to the present embodiment. The money handling apparatus 1 includes a coin handling apparatus 10 that performs a coin depositing process and a coin dispensing process, a banknote handling apparatus 11 that performs a banknote depositing process and a banknote dispensing process, and a terminal device that functions as an operation/display unit 170 to use the coin handling apparatus 10 and the banknote handling apparatus 11. The apparatus shown in FIG. 1 is an example and does not limit the configuration of the money handling apparatus 1. For example, the coin handling apparatus 10 and the banknote handling apparatus 11 may be integrated into a single apparatus. The operation/display unit 170 may be included in the money handling apparatus 1. The operation/display unit 170 may be separated into an operation unit and a display. The installation place and the usage purpose of the money handling apparatus 1 are not particularly limited. The description will be continued for a case where the money handling apparatus 1 shown in FIG. 1 is installed in a store where transactions with customers are performed.

The money handling apparatus 1 receives an operation relating to storage unit setting in which one or more denominations are assigned to each of a plurality of storage units in the coin handling apparatus 10 and the banknote handling apparatus 11 (S1). A clerk of the store can specify one or more denominations to be assigned to each storage unit by operating the operation/display unit 170.

When the customer purchases an item in the store, a settlement process is started by using the operation/display unit 170. For example, the price of the item is inputted by using the operation/display unit 170 composed of a touch-panel type liquid crystal display and thereby a transaction amount is determined. The transaction amount is displayed on the operation/display unit 170. The customer confirms the transaction amount displayed on the operation/display unit 170 and uses the money handling apparatus 1 to perform a depositing process to pay for the transaction amount by money i.e., in cash (S2). Of the money paid by the customer, banknotes are received by a depositing unit 210 of the banknote handling apparatus 11 while coins are received by a depositing unit 110 of the coin handling apparatus 10. The banknote handling apparatus 11 recognizes and counts the banknotes received in the depositing unit 210, and stores each banknote into a storage unit corresponding to the denomination of the banknote, based on the storage unit setting. Likewise, the coin handling apparatus 10 recognizes and counts the coins received in the depositing unit 110, and stores each coin into a storage unit corresponding to the denomination of the coin, based on the storage unit setting. The operation unit to be operated by the customer may be provided separately from the operation/display unit 170 operated by the clerk.

If the deposited amount that is the total amount of banknotes and coins deposited into the money handling apparatus 1 exceeds the transaction amount and therefore it is necessary to return change to the customer, the money handling apparatus 1 performs a dispensing process (S3). Of the change, banknotes are fed out from the storage units inside the banknote handling apparatus 11 and discharged from a dispensing unit 240 while coins are fed out from the storage units inside the coin handling apparatus 10 and discharged from a dispensing unit 140. The customer can receive the change discharged via the dispensing units 140, 240.

For highly efficient execution of the dispensing process, the money handling apparatus 1 can review the storage unit setting based on the contents of dispensing processes performed in the past, and change the storage unit setting, i.e., assignment of denominations to the respective storage units (S4). The money handling apparatus 1 that has changed the denominations assigned to the storage units can perform a replacement process for replacing money stored in these storage units (S5). For example, when denomination assignment has been changed so that the first denomination of the first storage unit and the second denomination of the second storage unit are replaced with each other, a replacement process is performed so that all the money of the first denomination is fed out from the first storage unit and stored in the second storage unit and all the money of the second denomination is fed out from the second storage unit and stored in the first storage unit.

The money handling apparatus 1 has features relating to the dispensing process, such as determination of a combination of money to be dispensed in the dispensing process, review of the storage unit setting based on the history information on the dispensing process, and the like. The banknote handling apparatus 11 and the coin handling apparatus 10 perform similar processes although the former handles banknotes and the latter handles coins. In the following, to avoid redundant descriptions, the dispensing process will be specifically described with the coin handling apparatus 10 as an example.

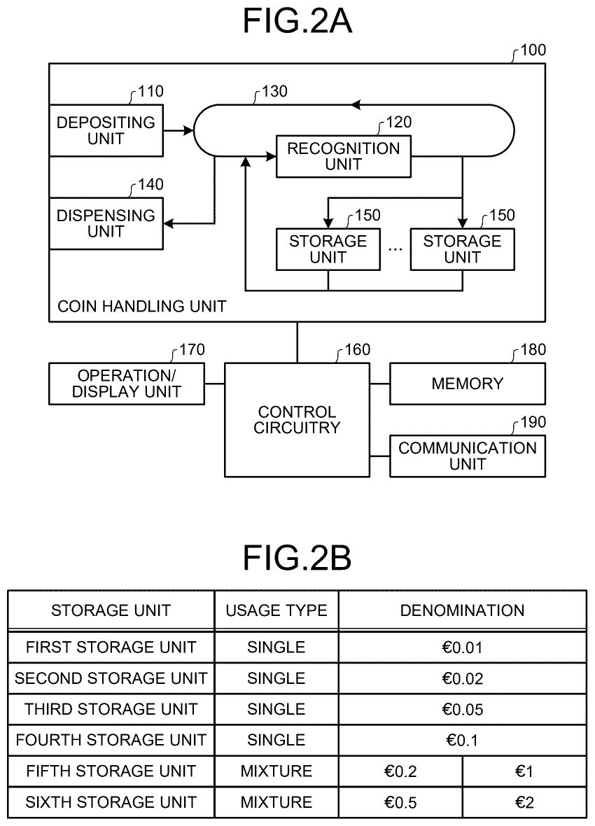

FIGS. 2A and 2B illustrate an outline of the coin handling apparatus 10. FIG. 2A schematically shows a configuration example of the coin handling apparatus 10. The coin handling apparatus 10 includes a coin handling unit 100, an operation/display unit 170, a control circuitry 160, a memory 180, and a communication unit 190. The coin handling unit 100 for handling coins includes a recognition unit 120 configured to recognize coins, a transport unit 130 configured to transport coins, and a plurality of storage units 150 configured to store coins therein, in addition to the depositing unit 110 and the dispensing unit 140 shown in FIG. 1.

The operation/display unit 170 functions as an operation unit to which various kinds of information relating to coin handling are inputted. The operation/display unit 170 also functions as a display to display various kinds of information relating to coin handling. The memory 180 is a non-volatile storage device used for storing various kinds of information necessary for the operation of the coin handling apparatus 10.

The communication unit 190 is used for communication with external devices wirelessly or via wires. For example, when the money handling apparatus 1 is used in a POS (Point of Sales) system, the money handling apparatus 1 communicates with a POS server via the communication unit 190. For example, when the money handling apparatus 1 is used in an unmanned store, the money handling apparatus 1 communicates with a server device that manages items sold in the unmanned store via the communication unit 190.

A program corresponding to the control circuitry 160 is stored in the memory 180 or a dedicated storage device, in advance. This program is executed by hardware such as a CPU, thereby realizing functions and operations of the control circuitry 160. The control circuitry 160 can control the respective components, based on information inputted through the operation/display unit 170 and the communication unit 190, and information stored in the memory 180. The functions and the operations of the coin handling apparatus 10 according to the present embodiment are realized by using the control circuitry 160.

The coin handling unit 100 can perform a plurality of kinds of coin handling including a depositing process and a dispensing process. The depositing unit 110 receives coins from outside the apparatus and feeds out the received coins to a transport path inside the apparatus. The transport unit 130 transports coins along the transport path connecting the depositing unit 110, the dispensing unit 140, the recognition unit 120, and the storage units 150. For example, the transport unit 130 is configured to include rollers and belts. Transport of coins in the present embodiment may include dropping of coins.

The recognition unit 120 recognizes coins being transported by the transport unit 130. The recognition unit 120 can recognize denomination and authenticity of each coin. The recognition unit 120 may recognize fitness of each coin, i.e., the degree of damage based on a predetermined criterion. For example, the recognition unit 120 is configured to include an image sensor and a plurality of other sensors.

The storage units 150 store therein coins having been transported along the transport path by the transport unit 130. Each storage unit 150 can feed out the stored coins toward the transport path. The number and configuration of the storage units 150 are not particularly limited as long as there are at least two storage units 150 each capable of storing coins and feeding out the stored coins. One or more storage units 150 may be detachably mounted to the coin handling apparatus 10. One or more storage units 150 may be configured to perform only storage of coins and not to perform feeding-out of coins. Hereinafter, the description will be continued for a case where there are six storage units 150 configured to perform storage and feeding-out of coins.

The dispensing unit 140 discharges coins having been transported along the transport path by the transport unit 130, to outside the apparatus. Coins fed out from the storage units 150 are discharged from the dispensing unit 140. Of coins received in the depositing unit 110 and fed out into the apparatus, a coin of a kind that cannot be stored in any storage unit 150 may be discharged from the dispensing unit 140.

In the depositing process, coins received in the depositing unit 110 are fed to the transport path inside the apparatus. The coins are transported along the transport path by the transport unit 130, recognized by the recognition unit 120 and stored in the storage units 150 corresponding to the denominations thereof.

In the dispensing process, a coin to be dispensed is fed out from a storage unit 150 and transported by the transport unit 130. In a case where a denomination to be dispensed and a denomination not to be dispensed are assigned to the same storage unit 150, a coin of the denomination not to be dispensed may be fed out therefrom. The recognition unit 120 recognizes the denomination of each coin fed out from the storage unit 150. The transport unit 130 transports, based on the recognition result, the coin of the denomination not to be dispensed, back to the original storage unit 150 from which that coin has been fed out. The transport unit 130 transports the coin of the denomination to be dispensed, to the dispensing unit 140, based on the recognition result. The coin of the denomination to be dispensed is discharged from the dispensing unit 140 to outside the apparatus while the coin of the denomination not to be dispensed is returned to the original storage unit 150 and stored therein.

When the user of the coin handling apparatus 10 specifies one or more denominations of coins to be stored in each of the plurality of storage units 150 by operating the operation/display unit 170, storage unit setting indicating the correspondence between the specified denominations and the storage units 150 is stored in the memory 180.

FIG. 2B shows an example of the storage unit setting stored in the memory 180. The storage unit setting includes fields of storage unit and denomination. The storage unit setting may further include a field of usage type. In the field of usage type, “single” indicates that the corresponding storage unit 150 is used as a single storage unit that stores coins of only one denomination, and “mixture” indicates that the corresponding storage unit 150 is used as a mixture storage unit that stores coins of a plurality of denominations. One denomination is assigned to a storage unit 150 used as the single storage unit, and a plurality of denominations are assigned to a storage unit 150 used as the mixture storage unit.

FIG. 2B shows an example in which the user has assigned denominations to six storage units 150, i.e., the first to sixth storage units 150, for coins of euro currency used in European union member states. Using two storage units 150 as mixture storage units allows the coin handling apparatus 10 including six storage units 150 to handle coins of eight denominations larger than the number of the storage units 150.

In each of the drawings showing denominations, including FIG. 2B, coins of denominations less than 1 euro are shown in euro units. For example, 1 euro cent coin is represented by adding the euro symbol to “0.01” obtained by converting into euros from euro cents. Hereinafter, in the same manner as that shown in the drawings, a euro cent coin is referred to as a coin represented by a numerical value converted into euros. Specifically, 1 euro cent coin, 2 euro cent coin, 5 euro cent coin, 10 euro cent coin, 20 euro cent coin, and 50 euro cent coin are respectively referred to as 0.01-euro coin, 0.02-euro coin, 0.05-euro coin, 0.1-euro coin, 0.2-euro coin, and 0.5-euro coin.

In the storage unit setting shown in FIG. 2B, 0.01 euro, 0.02 euro, 0.05 euro, and 0.1 euro are respectively assigned to the first to fourth storage units 150 that are single storage units. 0.2 euro and 1 euro are assigned to the fifth storage unit 150 that is a mixture storage unit. 0.5 euro and 2 euro are assigned to the sixth storage unit 150 that is a mixture storage unit. Although FIG. 2B shows an example of a mixture storage unit in which two denominations are assigned to one storage unit 150, three or more denominations can be assigned to one storage unit 150. Hereinafter, the six storage units 150 may be distinguished from each other by referring to them as the first to sixth storage units with numerical symbols being omitted, or by referring to them as single storage units or mixture storage units.

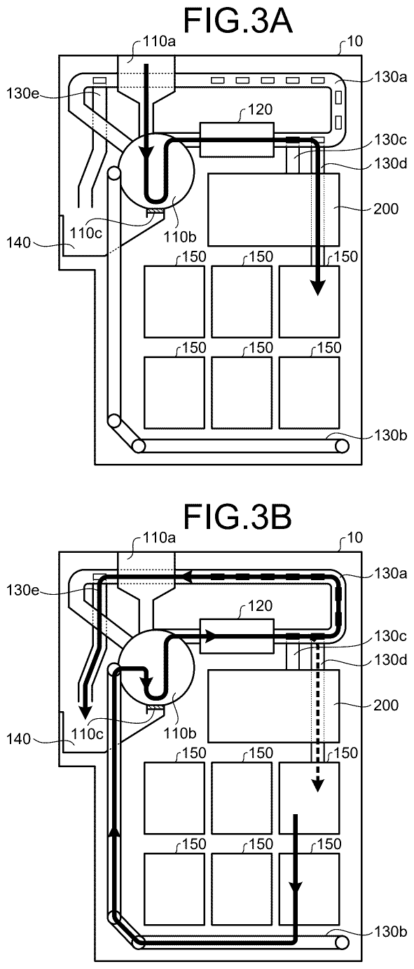

FIGS. 3A and 3B are schematic cross-sectional views illustrating an example of a specific configuration of the coin handling apparatus 10. As shown in FIGS. 3A and 3B, the coin handling apparatus 10 may include an overflow storage unit 200 that stores therein coins not to be used for a dispensing process, in addition to the components shown in FIG. 2A. If a storage unit 150 becomes full of coins and cannot store a coin therein, the overflow storage unit 200 is used to store this coin.

The depositing unit 110 (110a to 110c) shown in FIGS. 3A and 3B includes an inlet 110a into which coins are inserted, a feeder 110b that receives the coins from the inlet 110a and feeds out the coins to the transport path, and a gate 110c for discharging the coins from the feeder 110b to the dispensing unit 140.

The transport unit 130 (130a to 130e) includes an upper transport unit 130a that transports the coins fed out from the feeder 110b, and a lower transport unit 130b that receives the coins fed out from the storage unit 150 and the overflow storage unit 200 to transport these coins toward the upper transport unit 130a. The transport unit 130 further includes a plurality of chutes 130c to 130e connected to the transport path of the upper transport unit 130a. The chute 130c connects the upper transport unit 130a to the overflow storage unit 200. The chute 130d connects the upper transport unit 130a to each of the storage units 150 in a one-to-one relationship. Although FIGS. 3A and 3B show one chute 130d connected to one storage unit 150, the chute 130d is provided corresponding to each storage unit 150. The chute 130e connects the upper transport unit 130a to the dispensing unit 140. Coins that are transported without dropping into the chutes 130c to 130e are returned to the feeder 110b.

FIG. 3A illustrates a depositing process. As shown by an arrow in FIG. 3A, in the depositing process, coins received in the inlet 110a drop into the feeder 110b. The feeder 110b can store therein a plurality of coins at the same time and feed out the coins one by one to the upper transport unit 130a. The upper transport unit 130a transports the coins fed out from the feeder 110b one by one along the transport path. Each of the coins being transported along the transport path is recognized by the recognition unit 120. Based on the recognition result, the chute 130d connected to the storage unit 150, to which the denomination of the coin is assigned, is opened. The coin drops from the transport path into the chute 130d and is stored in the storage unit 150. Although the arrow shown in FIG. 3A indicates that the coins are stored in one storage unit 150, the destination of each coin is determined based on the storage unit setting. Although not shown in FIG. 3A, if a storage unit 150 is full of coins and a coin cannot be stored therein, this coin drops through the chute 130c and is stored in the overflow storage unit 200. The gate 110c of the feeder 110b is used to return, to outside the apparatus, a foreign object that cannot be fed out from the feeder 110b, a coin that cannot be recognized by the recognition unit 120 and is returned to the feeder 110b, and the like. When the gate 110c is opened, the foreign object and the coin remaining in the feeder 110b drop into the dispensing unit 140 so as to be taken out from the apparatus.

FIG. 3B illustrates a dispensing process. As shown by an arrow in FIG. 3B, in the dispensing process, coins to be dispensed are fed out from the storage unit 150 and drop onto the transport path of the lower transport unit 130b. Each storage unit 150 can continuously feed out coins one by one. The lower transport unit 130b can receive a plurality of coins fed out from one or more storage units 150 at the same time and transport the coins one by one toward the upper transport unit 130a. The coins transported by the lower transport unit 130b drop into the feeder 110b. The coins dropped into the feeder 110b are fed out one by one to the upper transport unit 130a and recognized by the recognition unit 120 as in the depositing process. Coins to be dispensed are transported to the dispensing unit 140 through the chute 130e. In a case where the storage unit 150 stores coins of a plurality of denominations, which include coins to be dispensed and coins not to be dispensed, in a mixed state, a coin not to be dispensed may be fed out from the storage unit 150. In this case, the fed-out coin not to be dispensed is returned to the original storage unit 150, from which the coin was fed out, through the chute 130d as shown by a broken line in FIG. 3B. Although the coins stored in the overflow storage unit 200 are not used for the dispensing process, the overflow storage unit 200 is configured to feed out the coins stored therein toward the lower transport unit 130b.

FIGS. 3A and 3B show an example and do not limit the configuration and operation of the coin handling apparatus 10. For example, in the dispensing process, coins may be directly transported from the lower transport unit 130b to the upper transport unit 130a without using the feeder 110b. The overflow storage unit 200 may be assigned a denomination not used for the dispensing process, so that coins received during the depositing process but cannot be stored in the storage units 150 are stored in the overflow storage unit 200.

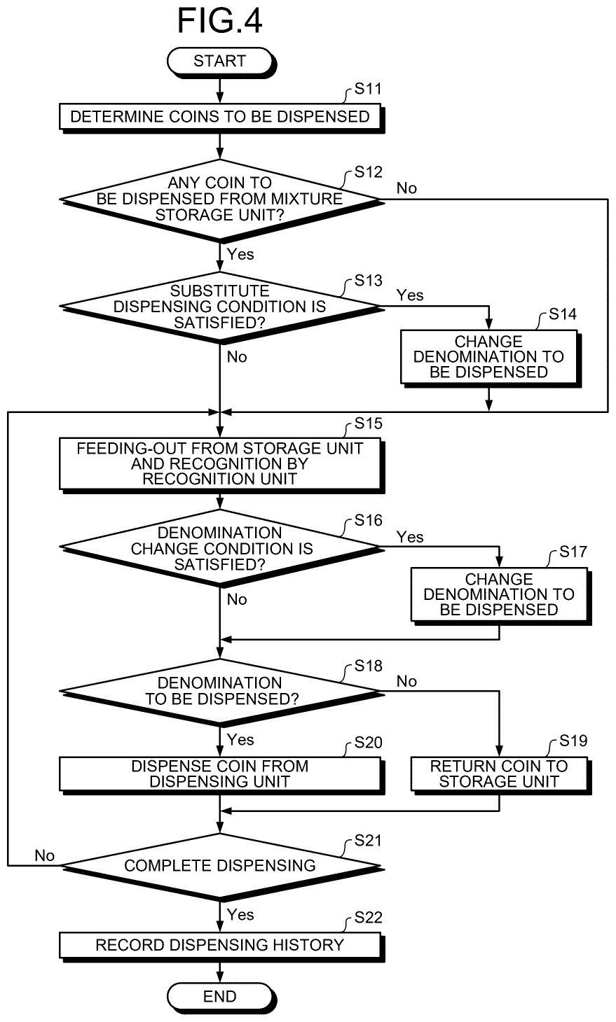

FIG. 4 is a flowchart showing a process flow performed by the coin handling apparatus 10 in the dispensing process. The description will be continued for a case where the storage unit setting shown in FIG. 2B is stored in the memory 180 of the coin handling apparatus 10.

When a dispensing process is required for dispensing change, the coin handling apparatus 10 determines coins to be dispensed, based on an amount to be dispensed (step S11). The coin handling apparatus 10 determines, as a combination of coins that make up the amount to be dispensed, the denominations and the number for each denomination of coins to be dispensed. That is, the denominations and the number of coins for each denomination to make up the change amount are determined.

Based on the denominations of coins stored in the storage units 150, the coin handling apparatus 10 determines the denominations and the number for each denomination of coins to be dispensed, so as to minimize the number of these coins. For example, if the change amount is 1.5 euros, the coin handling apparatus 10 determines to dispense a total of two coins that are one 1-euro coin from the fifth storage unit and one 0.5-euro coin from the sixth storage unit. The determination of the denominations of coins to be dispensed is performed by using all the denominations, regardless of whether they are assigned to the single storage units or the mixture storage units.

The coin handling apparatus 10 determines whether the coins determined to be dispensed include a coin stored in the mixture storage unit (step S12). If the coins to be dispensed do not include a coin stored in the mixture storage unit (step S12; No), the process proceeds to step S15, and the process for feeding out the coins from the storage units 150 is started.

If the coins to be dispensed include a coin stored in the mixture storage unit (step S12; Yes), the coin handling apparatus 10 determines whether the coin(s) of the mixture storage unit satisfy a substitute dispensing condition prepared in advance (step S13). If the coin(s) to be dispensed from the mixture storage unit do not satisfy the substitute dispensing condition (step S13; No), the combination of the denominations and the number of coins for each denomination determined in step S11 is not changed. If the coin(s) satisfy the substitute dispensing condition (step S13; Yes), the coin handling apparatus 10 changes the denominations of the coins to be dispensed (step S14).

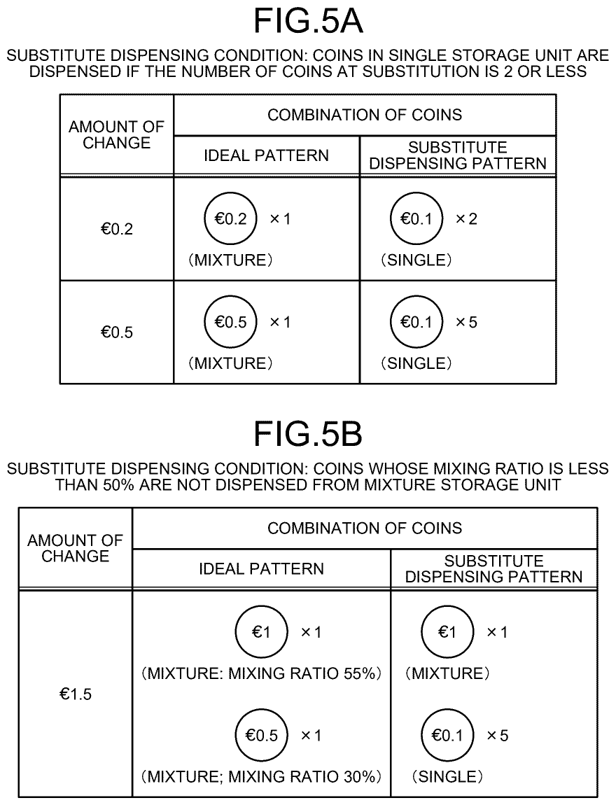

FIGS. 5A and 5B each illustrates the substitute dispensing condition. FIG. 5A illustrates the substitute dispensing condition based on the number of substitute coins to be dispensed per original coin. This substitute dispensing condition is set so that, when the denomination of original coins determined to be dispensed from a mixture storage unit is changed to the denomination of a single storage unit, if the number of coins of the denomination after the change is equal to or less than a threshold set for one original coin before the change, the substitute coins in the single storage unit are fed out instead of the original coins in the mixture storage unit. The description will be continued with an example in which the threshold is set to two.

For example, as shown in FIG. 5A, if the change amount is 0.2 euros, the coin handling apparatus 10 determines that the combination of coins to be dispensed is one 0.2-euro coin, as an ideal pattern that minimizes the number of coins making up the change amount (step S11). Since 0.2-euro coins are stored in the mixture storage unit (step S12; Yes), the coin handling apparatus 10 determines whether it is possible to perform substitute dispensing, i.e., dispensing coins from a single storage unit instead of one 0.2-euro coin from the mixture storage unit, based on the substitute dispensing condition (step S13). Even if the denomination to be dispensed is changed from 0.2 euro of the mixture storage unit to 0.1 euro of the single storage unit, the number of 0.1-euro coins to be dispensed instead of one 0.2-euro coin is two, which is not larger than the threshold, as shown in the substitute dispensing pattern in FIG. 5A. In other words, even if the 0.2-euro coin is substituted by the 0.1-euro coins, the number of coins for substitute dispensing per 0.2-euro coin is two, which does not exceed two set as the threshold. Therefore, the coin handling apparatus 10 determines that the substitute dispensing condition is satisfied (step S13; Yes) and changes the denomination to be dispensed (step S14). As a result, the denomination to be dispensed is changed from 0.2 euro to 0.1 euro, and the combination of the coins to be dispensed from the coin handling apparatus 10 is changed from one 0.2-euro coin to two 0.1-euro coins. That is, dispensing of one 0.2-euro coin from the mixture storage unit is changed to dispensing of two 0.1-euro coin from the single storage unit. The threshold is set per coin before the change. Therefore, for example, even if the change amount is 0.4 euros consisting of two 0.2-euro coins, it is determined that the substitute dispensing condition is satisfied, and four 0.1-euro coins are dispensed from the single storage unit.

On the other hand, if the change amount is 0.5 euros as shown in FIG. 5A, the coin handling apparatus 10 determines that the ideal pattern is one 0.5-euro coin stored in the mixture storage unit (step S11). Instead of dispensing one 0.5-euro coin from the mixture storage unit (step S12; Yes), the coin handling apparatus 10 determines whether it is possible to perform substitute dispensing, i.e., dispensing coins from a single storage unit (step S13). As shown in FIG. 5A, in the substitute dispensing pattern for this case, the total number of 0.1-euro coins to be dispensed is five, which exceeds two set as the threshold. That is, even in the substitute dispensing pattern that minimizes the number of substitute coins to be dispensed, the number of the substitute coins exceeds the threshold of two. Therefore, the coin handling apparatus 10 determines that the substitute dispensing condition is not satisfied (step S13; No) and does not change the denomination of the coin to be dispensed. As a result, the combination of the coins to be dispensed from the coin handling apparatus 10 is one 0.5-euro coin in this case.

FIG. 5B illustrates the substitute dispensing condition based on the mixing ratio of coins in each mixture storage unit. This substitute dispensing condition is set so that, if the mixing ratio of original coins determined to be dispensed from a mixture storage unit is less than a preset threshold, substitute coins in a single storage unit are fed out instead of the original coins in the mixture storage unit. The mixing ratio is a ratio of the number of coins of each denomination in one mixture storage unit to the number of all coins stored in the mixture storage unit. For example, assuming that the number of all coins stored in the mixture storage unit is 500, if the number of coins of denomination A is 200, the mixing ratio of the coins of denomination A is 40% (=200 (number of coins of denomination A)/500 (number of all coins)). The description will be continued with an example in which the threshold of the mixing ratio is set to 50% and the substitute dispensing condition is set so that coins whose mixing ratio in the mixture storage is less than 50% are substituted with coins in a single storage unit.

As shown in FIG. 5B, if the change amount is 1.5 euros, the coin handling apparatus 10 determines that the combination of coins to be dispensed is one 1-euro coin and one 0.5-euro coin, as an ideal pattern that minimizes the number of coins making up the change amount (step S11). Since these coins are stored in the mixture storage units (step S12; Yes), the coin handling apparatus 10 determines whether it is possible to perform substitute dispensing, based on the substitute dispensing condition (step S13). If the mixing ratio of 1-euro coins in the fifth storage unit is 55% as shown in FIG. 5B, since the mixing ratio exceeds 50% set as the threshold, the coin handling apparatus 10 determines that the substitute dispensing condition is not satisfied (step S13; No) and does not change the denomination of coins to be dispensed.

On the other hand, the mixing ratio of 0.5-euro coins in the sixth storage unit is 30%. This mixing ratio is less than the threshold of 50% and therefore, the coin handling apparatus 10 determines that the substitute dispensing condition is satisfied (step S13; Yes) and changes the denomination of original coins to be dispensed, to the denomination assigned to a single storage unit (step S14). Of the denominations assigned to the single storage units, a combination of coins that can be dispensed in the minimum number, instead of the 0.5-euro coin, is five 0.1-euro coins. Therefore, the coin handling apparatus 10 changes the denomination to be dispensed, from 0.5 euro to 0.1 euro. As a result, the combination of the coins to be dispensed from the coin handling apparatus 10 is changed from one 1-euro coin and one 0.5-euro coin, to one 1-euro coin and five 0.1-euro coins.

Priorities are set for the substitute dispensing conditions. For example, the priority of the substitute dispensing condition based on the mixing ratio shown in FIG. 5B is set higher than the priority of the substitute dispensing condition based on the number of substitutes per coin shown in FIG. 5A. In the example shown in FIG. 5B, one 0.5-euro coin is substituted by five 0.1-euro coins. The number of 0.1-euro coins exceeds the threshold of two set for the substitute dispensing condition based on the number of substitutes per coin described with reference to FIG. 5A. In this case, the coin handling apparatus 10 determines to dispense five 0.1-euro coins instead of the 0.5-euro coin, based on the priority of these substitute dispensing conditions. It is an example, and only one of the substitute dispensing condition based on the number of substitutes per coin and the substitute dispensing condition based on the mixing ratio may be used in the apparatus.

As described above, when performing the dispensing process, the coin handling apparatus 10 determines whether or not to perform substitute dispensing by changing the denomination of original coins determined to be fed out from the mixture storage unit to the denomination of substitute coins in a single storage unit, before feeding out coins from the mixture storage unit. When the number of substitute coins to be dispensed after changing the denomination, per coin, is equal to or less than a predetermined number and/or when the mixing ratio of substitute coins in the mixture storage unit is low, the coin handling apparatus 10 determines to cancel the dispensing of the original coins from the mixture storage unit and dispense substitute coins from a single storage unit. After the determination, the coin handling apparatus 10 starts feeding out of the substitute coins. This avoids the situation in which, after starting the feeding-out of original coins from the mixture storage unit, the original coins to be dispensed are not readily fed out, and it takes a long time until all the coins corresponding to the change amount are dispensed.

The determination as to whether the substitute dispensing condition is satisfied and the control corresponding to the determination (steps S12 to S14) are not essential for the coin handling apparatus 10. The determination and/or the control may be performed only when a predetermined condition is satisfied. For example, the determination as to whether the substitute dispensing condition is satisfied and/or the corresponding control may be performed only when the inventory amount of coins of a certain denomination stored in a mixture storage unit becomes less than a predetermined threshold or when the ratio of coins of a certain denomination in a mixture storage unit becomes less than a predetermined threshold ratio.

After the denominations and the number for each denomination of coins to be dispensed are determined as described above, the coin handling apparatus 10 starts a process for feeding out the coins from the storage units 150 and recognizes the coins by the recognition unit 120, as shown in FIG. 4 (step S15).

As described with reference to FIGS. 3A and 3B, the coin handling apparatus 10 is configured to drop the coins fed out from the storage units 150 to the lower transport unit 130b and transport these coins one by one to the recognition unit 120. When performing a dispensing process, the coin handling apparatus 10 can continuously feed out a plurality of coins from each storage unit 150.

The single storage unit continuously feeds out the number of coins to be dispensed. For example, when two coins need to be dispensed from one single storage unit, the two coins are continuously fed out, rather than feeding out one coin and waiting for this coin to be transported by the lower transport unit 130b before dispensing the remaining one coin. By continuously feeding out all the coins to be dispensed, regardless of the transport status of the lower transport unit 130b, the time required to complete the dispensing process is expected to be reduced.

The mixture storage unit may be configured to continuously feed out a larger number of coins than the number of coins to be dispensed. When one coin needs to be fed out from the mixture storage unit in the dispensing process, a plurality of coins can be continuously fed out from the mixture storage unit regardless of the transport status by the lower transport unit 130b and the recognition status by the recognition unit 120. Thus, the time required to complete the dispensing process will be reduced, compared to a case where the apparatus waits until one coin is fed out from the mixture storage unit and it is determined, based on the recognition result by the recognition unit 120, that the denomination of this coin is not the denomination to be dispensed, before dispensing the next coin from the mixture storage unit.

For example, the coin handling apparatus 10 may be configured to continuously feed, from the mixture storage unit, the number of coins calculated by dividing 100% by the value of the mixing ratio. When dispensing one coin of denomination A stored in the mixture storage unit, if the mixing ratio of denomination A is 50%, two coins (=100%/mixing ratio 50%) are fed out continuously from the mixture storage unit to dispense the one coin. If the mixing ratio is 20%, five coins (=100%/mixing ratio 20%) are fed out continuously from the mixture storage unit to dispense the one coin. Likewise, when dispensing two coins with the mixing ratio of 508, two coins per coin to be dispensed, i.e., a total of four coins, are fed out continuously. When dispensing two coins with the mixing ratio of 20%, five coins per coin to be dispensed, i.e., a total of ten coins, are fed out continuously. If the number calculated by dividing 100% by the value of the mixing ratio is a decimal, the number may be determined by rounding up, rounding down, rounding to the nearest whole number, or the like. The method for determining the number of coins to be fed out from the mixture storage unit is an example and is not particularly limited. A predetermined number of coins, which is set in advance, may be continuously fed out regardless of the mixing ratio. For example, three coins are fed out from the mixture storage unit per each coin to be fed out therefrom.

The coins thus fed out from the storage units 150 and dropped on the lower transport unit 130b are transported one by one to the recognition unit 120 and recognized. Based on the recognition result, each coin is returned to the original mixture storage unit or dispensed from the dispensing unit 140.

In the coin handling apparatus 10, even after denominations and the number for each denomination of coins to be dispensed have been determined and feeding-out of the coins from the storage unit 150 has been started, the denominations of coins to be dispensed can be changed according to need. Specifically, as shown in FIG. 4, the coin handling apparatus 10 determines whether a preset denomination change condition is satisfied (step S16). If the denomination change condition is satisfied (step S16; Yes), the coin handling apparatus 10 changes the denominations of coins to be dispensed (step S17). If the denomination change condition is not satisfied (step S16; No), the process is continued without changing the denominations of the coins to be dispensed. The denomination change condition will be described later.

The coin handling apparatus 10 recognizes each coin fed out from the storage units 150, by using the recognition unit 120, to determine whether the coin is of the denomination to be dispensed (step S18). If the coin is not of the denomination to be dispensed (step S18; No), the coin handling apparatus 10 returns this coin to the original storage unit 150 (step S19). If the coin is of the denomination to be dispensed (step S18; Yes), the coin handling apparatus 10 dispenses this coin from the dispensing unit 140 (step S20).

The processes in steps S15 to S20 are repeated until all the coins equivalent to the amount to be dispensed, i.e., the change amount, are dispensed from the coin handling apparatus 10 (step S21; No). When all the coins for the change have been dispensed (step S21; Yes), the coin handling apparatus 10 records the dispensing history in the memory 180 (step S22) and ends the dispensing process.

The denomination change condition in step S16 shown in FIG. 4 will be described. For example, the denomination change condition is set so that, if a coin to be dispensed is not fed out from the mixture storage unit even when a time set as a threshold in advance has elapsed from the start of the feeding-out of coins, the denomination of the coin to be dispensed is changed.

The denomination change condition may be set so that the coin feeding time from each mixture storage unit is measured separately, and the denomination of coins to be dispensed from a mixture storage unit that has reached a threshold time is changed to the denomination of a single storage unit. Alternatively, the denomination change condition may be set so that the coin handling apparatus 10 starts measuring the time from the start of feeding-out of coins from any of the storage units 150, and when the time reaches a threshold time, the coin handling apparatus 10 changes all the denominations of coins to be dispensed, to the denominations of coins stored in the single storage units.

For example, the denomination change condition may be set so that, when the total number of coins whose denomination has been recognized by the recognition unit 120 as not to be dispensed and which have been returned to the mixture storage units reaches the number set as a threshold in advance, the denomination of coins to be dispensed is changed.

The denomination change condition may be set so that the number of coins returned to each mixture storage unit is counted separately, and if there is a mixture storage unit for which the number has reached a threshold number, the denomination of coins to be dispensed from this mixture storage unit is changed to the denomination of coins in a single storage unit. The denomination change condition may be set so that the total number of coins returned to the respective mixture storage units is counted, and if the total number has reached a threshold number, all the denominations of coins to be dispensed are changed to the denominations of single storage units.

For example, when feeding-out of coins is started to dispense 0.5 euros from the sixth storage unit that stores therein 2-euro coins and 0.5-euro coins, and if the elapsed time from the start of the feeding-out reaches the preset threshold (e.g., 10 seconds) before the first 0.5-euro coin is fed out, it is determined that the denomination change condition is satisfied (step S16; Yes). Also, when the number of 2-euro coins returned to the sixth mixture storage unit reaches the preset threshold (e.g., 5 pieces), it is determined that the denomination change condition is satisfied (step S16; Yes). When the denomination change condition has been satisfied, the denomination of the coin to be dispensed is changed from “0.5 euro” in the mixture storage unit to the denomination of coins stored in a single storage unit (step S17). The coin handling apparatus 10 feeds out and dispenses five 0.1-euro coins from the single storage unit, instead of one 0.5-euro coin in the mixture storage unit, so that 0.5 euros can be dispensed by combining the minimum number of coins stored in the single storage unit, for example. As a result, the amount of 0.5 euros, which was originally planned to be dispensed with the combination of one 0.5-euro coin, is dispensed with the combination of five 0.1-euro coins.

The denomination change condition can be set so that the denominations and the number for each denomination of coins to be fed out from the mixture storage unit are changed based on the order of the denominations recognized by the recognition unit 120. The denomination change condition may be set so that, even when the denomination of a coin is recognized by the recognition unit 120 as a denomination not to be dispensed, if the amount to be dispensed can be dispensed with a combination including the recognized denomination, the denominations and the numbers for each denomination of coins equivalent to the amount to be dispensed are changed so as to include the recognized denomination, and the coins are dispensed based on the changed combination.

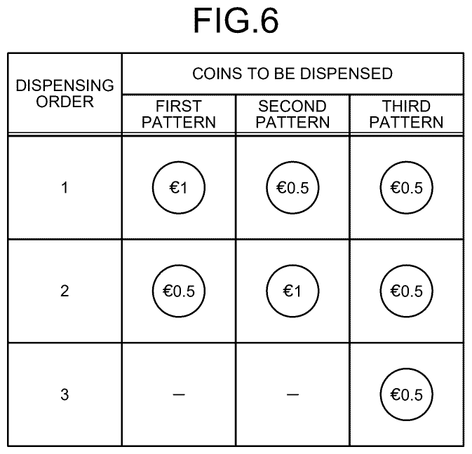

FIG. 6 illustrates the denomination change condition based on the recognition order. It is assumed that the coin handling apparatus 10 has determined to dispense an amount of 1.5 euros with a combination of one 1-euro coin and one 0.5-euro coin in the mixture storage units and has started feeding-out of the coins from the storage units 150.

In the dispensing process, 0.2-euro coins or 1-euro coins are fed out from the fifth storage unit and 0.5-euro coins or 2-euro coins are fed out from the sixth storage unit. For example, as described above, a plurality of coins are continuously fed out from the fifth storage unit and the sixth storage unit, and the coins dropped on the lower transport unit 130b are transported one by one to the recognition unit 120 and recognized. Since a 2-euro coin exceeds the amount of 1.5 euros to be dispensed, this coin is always returned to the sixth storage unit.

The recognition unit 120 recognizes the coins one by one in order. When dispensing one 1-euro coin and one 0.5-euro coin, if a 1-euro coin is obtained first and then a 0.5-euro coin is obtained as shown in the first pattern in FIG. 6, these two coins are dispensed from the coin handling apparatus 10. If a 0.5-euro coin is obtained first, the coin handling apparatus 10 waits for one 1-euro coin to be obtained and then dispenses this coin. If a 0.5-euro coin is obtained and then a 1-euro coin is obtained as shown in the second pattern in FIG. 6, these two coins are dispensed from the coin handling apparatus 10.

It is assumed that, when waiting for one 1-euro coin to be obtained following the feeing out of one 0.5-euro coin, a 0.5-euro coin is obtained again instead of the 1-euro coin. In this case, even if the second 0.5-euro coin is included in the change, the change amount of 1.5 euros can be dispensed with this coin. Therefore, the coin handling apparatus 10 determines that the denomination change condition is satisfied (FIG. 4, step S16; Yes), and changes the denomination of the coin to be dispensed, from 1 euro to 0.5 euro (step S17). Based on this change, the coin handling apparatus 10 determines the second 0.5-euro coin to be dispensed in addition to the first 0.5-euro coin (step S18; Yes). These two coins are dispensed from the coin handling apparatus 10 via the dispensing unit 140 (step S20).

As a result, the coin handling apparatus 10 finally dispenses three 0.5-euro coins as shown in the third pattern in FIG. 6. The coins finally dispensed from the apparatus are changed depending on the order of the denominations of coins obtained during the dispensing process. For example, there is a case where one 0.2-euro coin is obtained after the first and second 0.5-euro coins and the denomination is changed again as the denomination change condition is satisfied. In this case, in addition to the two 0.5-euro coins, one 0.2-euro coin and three 0.1-euro coins are dispensed as a result. There may be a case where two 0.2-euro coins are obtained after the two 0.5-euro coins, and it leads to a result in which the two 0.5-euro coins, the two 0.2-euro coins, and one 0.1-euro coin are dispensed as the change amount of 1.5 euros from the coin handling apparatus 10.

As described above, the coin handling apparatus 10 can change the combination of the denominations and the number for each denomination of coins to be dispensed, according to the order of the coins fed out from the mixture storage unit during the dispensing process, and dispense the coins based on the changed combination. By changing the denominations and the number of coins for each denomination, according to the denominations of coins fed out from the mixture storage unit, the time required to complete the dispensing process is expected to be reduced.

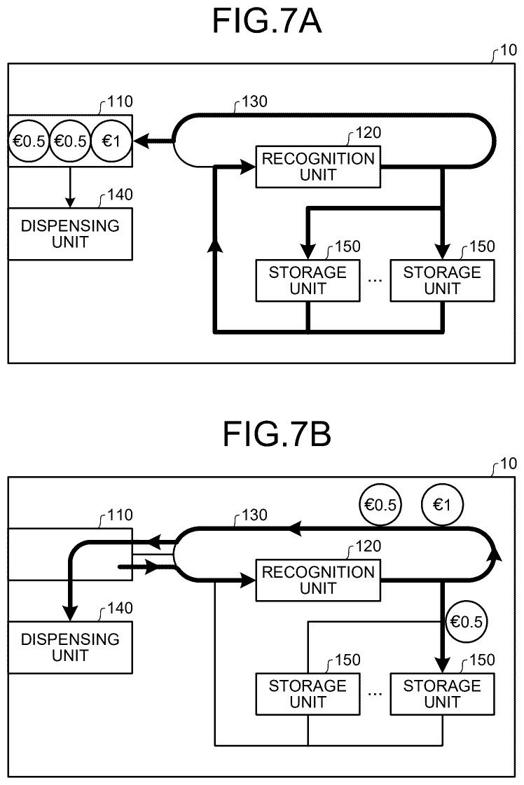

If the coin handling apparatus 10 can temporarily store the coins to be dispensed inside the apparatus, the temporary storage may be performed to change the coins to be dispensed. FIG. 7 illustrates an example of temporary storage and dispensing of coins. The coin handling apparatus 10 shown in FIG. 7 is configured to use the depositing unit 110 to temporarily store coins to be dispensed, and dispense the coins stored in the depositing unit 110 via the dispensing unit 140. For example, an openable/closable gate is disposed at the bottom surface of the depositing unit 110, and when this gate is opened, the coins temporarily stored in the depositing unit 110 are dropped into the dispensing unit 140 to dispense these coins from the coin handling apparatus 10. Specifically, the coin handling apparatus 10 in the example shown in FIGS. 3A and 3B may be configured to perform the dispensing process in which coins are transported from the lower transport unit 130b directly to the upper transport unit 130a, the recognized coins are transported to the feeder 110b of the depositing unit 110 for the temporarily storage, and the temporarily stored coins are dispensed from the dispensing unit 140 by opening the gate 110c of the feeder 110b.

In the coin handling apparatus 10 shown in FIG. 7, of the coins fed out from the storage units 150 and recognized by the recognition unit 120, coins to be dispensed are temporarily stored in the depositing unit 110 while coins not to be dispensed are returned to the storage units 150. For example, it is assumed that, during the dispensing process for dispensing one 1-euro coin and one 0.5-euro coin, since two 0.5-euro coins are successively obtained while no 1-euro coin is obtained, denomination change is performed and it is determined to dispense three 0.5-euro coins, as described with reference to FIG. 6.

In this case, two 0.5-euro coins have already been temporarily stored in the depositing unit 110, and the coin handling apparatus 10 is waiting for one more 0.5-euro coin to dispense the total amount of 1.5 euros. However, if a coin obtained next is a 1-euro coin, the amount of 1.5 euros can be dispensed by combining this 1-euro coin with one 0.5-euro coin temporarily stored in the depositing unit 110. Therefore, the coin handling apparatus 10 again changes the denominations of coins to be dispensed, from 0.5 euro coin to 1 euro coin, determines the obtained 1-euro coin as a coin to be dispensed, and transports this coin to the depositing unit 110 for temporarily storage, as shown in FIG. 7A. As a result, although the process is being performed to dispense 1.5 euros, a total amount of 2 euros, consisting of two 0.5-euro coins and one 1-euro coin, are temporarily stored in the depositing unit 110.

Then, as shown in FIG. 7B, the coin handling apparatus 10 feeds out the temporarily stored two 0.5-euro coins and one 1-euro coin from the depositing unit 110, one by one, to the transport path, and recognizes the coins by the recognition unit 120. Based on the recognition result, the coin handling apparatus 10 returns one 0.5-euro coin to the original mixture storage unit, and dispenses one 1-euro coin and one 0.5-euro coin from the dispensing unit 140 via the depositing unit 110. Thus, the coin handling apparatus 10 can finally dispense the amount of 1.5 euros with the initially determined combination of one 1-euro coin and one 0.5-euro coin.

As described above, the coin handling apparatus 10 can change the combination of the denominations and the number for each denomination of coins to be dispensed, based on the coins which are temporarily stored during the dispensing process and on the denominations of the coins recognized by the recognition unit 120, and dispense the coins based on the changed combination. Specifically, as described above, if the amount to be dispensed can be dispensed by replacing one or more coins being temporarily stored with a coin newly recognized by the recognition unit 120, replacement of coins is performed to dispense the coins equivalent to the amount to be dispensed. Thus, the time required to complete the dispensing process is expected to be reduced.

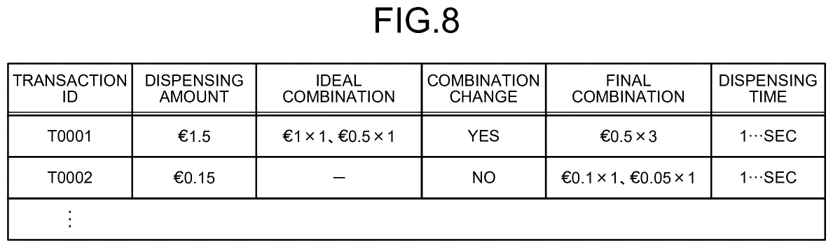

As described with reference to FIG. 4, after completing the dispensing process, the coin handling apparatus 10 records the dispensing history in the memory 180. FIG. 8 shows an example of the dispensing history. The dispensing history includes fields of “transaction ID” (identification number), “dispensing amount”, “ideal combination”, “combination change”, “final combination”, and “dispensing time”.

Under the field of “transaction ID”, an identification number to uniquely identify each transaction in which the coin handling apparatus 10 performs a dispensing process, is registered. Under the field of “dispensing amount”, the amount of change returned to the customer at the transaction, i.e., the total amount of coins dispensed by the coin handling apparatus 10, is registered. Under the field of “ideal combination”, a combination, i.e., denominations and the number for each denomination of coins, in the case where the change is returned with the minimum number of coins by using coins of denominations assigned to the storage units 150, is registered. Under the field of “ideal combination”, a combination of coins, which is initially determined by the coin handling apparatus 10 after starting the dispensing process, is registered.

The coin handling apparatus 10 starts the dispensing process with the ideal combination, but the combination of the coins to be dispensed may be changed during the dispensing process as described above. Under the field of “combination change”, information as to whether the denomination in the ideal combination was changed to another denomination during the dispensing process is registered. Under the field of “final combination”, a combination, i.e., denominations and the number for each denomination, of the coins finally dispensed from the coin handling apparatus 10 is registered. Under the field of “dispensing time”, the processing time required for the dispensing process is registered. If the ideal combination and the final combination are the same, as in the case of transaction ID “T0002” shown in FIG. 8, this combination is not registered under the field of “ideal combination” but is registered under the field of “final combination”. In other words, when the ideal combination is not registered for a transaction, the final combination is the same as the ideal combination of that transaction.

For example, the dispensing history of transaction ID “T0001” shown in FIG. 8 indicates that, after the dispensing process was started with the ideal combination of one 1-euro coin and one 0.5-euro coin, denomination change was performed during the dispensing process, and 1.5 euros were dispensed with the final combination of three 0.5-euro coins. The dispensing history of transaction ID “T0002” indicates that the denominations were not changed during the dispensing process, and a total amount of 0.15 euros, consisting of one 0.1-euro coin and one 0.05-euro coin, was dispensed with the final combination identical to the ideal combination.

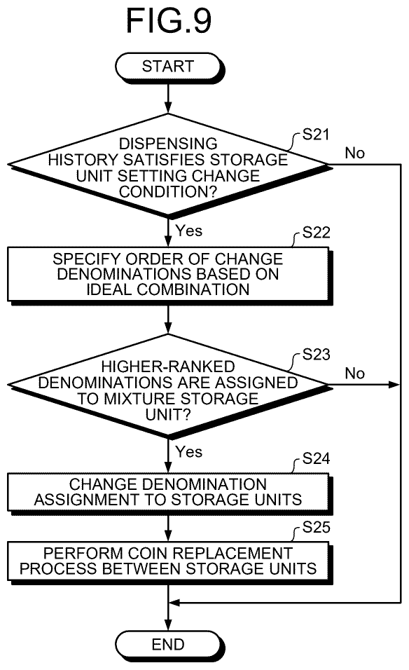

The coin handling apparatus 10 can change the storage unit setting, based on the dispensing history. FIG. 9 illustrates an example of a process of changing the storage unit setting. For example, a condition for changing the storage unit setting is prepared in advance and stored in the memory 180. The coin handling apparatus 10 starts the process shown in FIG. 9 at a predetermined timing, based on the condition for changing the storage unit setting. For example, the process shown in FIG. 9 is performed each time a predetermined period has elapsed, e.g., once a day, once a week, or once a month, based on the dispensing histories recorded within the predetermined period.

The coin handling apparatus 10 determines whether the recorded dispensing history satisfies the condition for changing the storage unit setting (step S21). For example, the coin handling apparatus 10 may determine that the change condition is satisfied when, among a plurality of dispensing histories recorded within the predetermined period, the number of transactions for which “Yes” is registered under the field of “combination change”, i.e., the number of transactions in which denomination change was performed during the dispensing process, exceeds the number of times set as a threshold in advance. The coin handling apparatus 10 may determine that the change condition is satisfied when the ratio of the number of transactions in which denomination change was performed to the total number of dispensing histories recorded within the predetermined period, exceeds a ratio set as a threshold in advance.

For example, the coin handling apparatus 10 may determine that the change condition is satisfied when, among the dispensing histories recorded within the predetermined period, a transaction in which the time recorded under the field of “dispensing time” exceeds the time set as a threshold in advance, is included. The coin handling apparatus 10 may determine that the change condition is satisfied when, among the dispensing histories recorded within the predetermined period, the number or ratio of transactions in which the dispensing time exceeds the time set as a threshold in advance, exceeds the number of times or the ratio set as a threshold in advance.

If the determination condition is not satisfied (step S21; No), the coin handling apparatus 10 ends the process without changing the storage unit setting. On the other hand, if the determination condition is satisfied (step S21; Yes), the coin handling apparatus 10 accumulates the number of coins for each denomination based on the dispensing histories recorded within the predetermined period, and specifies the ranking of the denominations (step S22). The number of coins, which should have been dispensed as change based on the ideal combination, is accumulated for each denomination.

Specifically, the accumulation of the number of coins for each denomination is performed for the dispensing histories shown in FIG. 8. The number of coins in the ideal combination is used for the calculation when the ideal combination is recorded for the transaction. The number of coins in the final combination is used for the calculation when the ideal combination is not recorded for the transaction. In the example shown in FIG. 8, regarding the dispensing process of the transaction ID “T0001”, one 1-euro coin and one 0.5-euro coin registered in the ideal combination are included in the accumulation target. Regarding the dispensing process of the transaction ID “T0002”, one 0.1-euro coin and one 0.05-euro coin registered in the final combination are included in the accumulation target.

Through the accumulation, the number of coins for each denomination, which would have been required for the dispensing processes if all the dispensing processes were performed without changing the denominations from the ideal combination, that is, the number of coins for each denomination which would have been originally required for the change dispensing processes, is calculated. The denominations are ranked in order from the one with the largest number of coins. Regarding the dispensing histories in which no ideal combination is registered, the final combination is the ideal combination. As a result, the number of coins for each denomination is accumulated for the ideal combinations of all the transactions registered in the dispensing histories, and the denominations are ranked in order from the one having the largest number of coins for the ideal combinations.

The coin handling apparatus 10 determines whether there is any denomination assigned to the mixture storage unit, among the denominations whose ranks are within a predetermined range from the one having the largest number of coins (step S23). For example, the determination is made for denominations up to a predetermined rank, such as the top three ranks. For example, the determination may be made for denominations within a predetermined percentage from the top, such as within the top 30% of all denominations.

If there is no denomination assigned to the mixture storage unit among the higher-ranked denominations (step S23; No), the coin handling apparatus 10 ends the process without changing the storage unit setting. Meanwhile, if there is a denomination assigned to the mixture storage unit among the higher-ranked denominations (step S23; Yes), the coin handling apparatus 10 changes the storage unit setting (step S24). The coin handling apparatus 10 changes the storage unit setting so that the higher-ranked denominations are assigned to single storage units. For example, based on the result of accumulation in step S22, denomination assignment is changed so that the higher-ranked denominations assigned to the mixture storage unit are replaced with the denominations assigned to the single storage units. The single storage units are selected in order from that of a denomination with the smallest accumulated number of coins, i.e., in order from a denomination of the lowest rank. By changing the denomination assignment, a denomination that is more frequently dispensed as change is assigned to a single storage unit and a denomination that is less frequently dispensed as change, compared to the denomination assigned to the single storage unit, is assigned to a mixture storage unit.

The method for changing the denomination assignment is not limited to the above described example in which whether or not to change the denomination assignment is determined in descending order of ranking of denominations in the accumulation result of the number of coins for each denomination based on the ideal combination. For example, regardless of the ranking, if a denomination higher in rank than a denomination assigned to the single storage unit is assigned to the mixture storage unit, the assignment of these denominations may be changed so that the higher-ranked denomination is assigned to the single storage unit and the lower-ranked denomination is assigned to the mixture storage unit. In other words, if the number of coins accumulated for the denomination assigned to the mixture storage unit is larger than the number of coins accumulated for the denomination assigned to the single storage unit, based on the ideal combination in the dispensing processes performed in the past, denomination assignment may be changed between the mixture storage unit and the single storage unit.

After changing the storage unit setting, the coin handling apparatus 10 performs a replacement process for replacing the coins in the corresponding storage units 150 with each other based on the changed storage unit setting (step S25). The timing at which the coin handling apparatus 10 performs the process shown in FIG. 9 can be set in advance. For example, the timing may be set so that the process shown in FIG. 9 is completed between the closing of the store for the day and the opening of the store on the next day, to prevent the process from affecting the business of the store. The process shown in FIG. 9 may be set to be performed on the day when the store is closed.

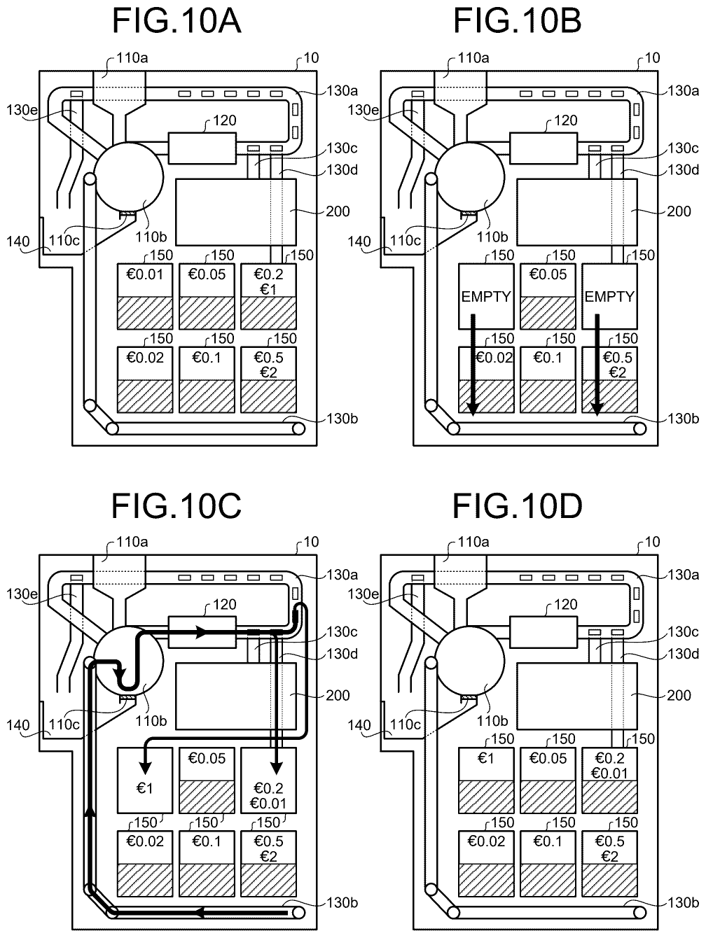

FIGS. 10A to 10D illustrate an example of a replacement process performed by the coin handling apparatus 10. FIG. 10A shows an example in which denominations are assigned to six storage units 150, based on the storage unit setting shown in FIG. 2B. It is assumed that the coin handling apparatus 10 has determined to change the denomination assignment in the storage unit setting shown in FIG. 2B to replace 1-euro coin assigned to the mixture storage unit with 0.01-euro coin assigned to the single storage unit. In other words, it is assumed that the denomination assignment is changed between the upper-left storage unit 150 and the upper-right storage unit 150 among the storage units 150 arranged in two rows and three columns as shown in FIG. 10.

In this case, as shown in FIG. 10B, the coin handling apparatus 10 feeds out all the coins from these two storage units 150, to which the replaced denominations are assigned, to the lower transport unit 130b in order to empty these two storage units 150.

As shown in FIG. 10C, the coin handling apparatus 10 transports the coins one by one from the lower transport unit 130b and recognizes the coins by the recognition unit 120. The coin handling apparatus 10 stores 1-euro coins into the emptied upper-left storage unit 150, and stores 0.2-euro coins and 0.01-euro coins into the emptied upper-right storage unit 150. That is, the coin handling apparatus 10 stores 1-euro coins into the single storage unit, and stores 0.2-euro coins and 0.01-euro coins into the mixture storage unit. As a result, the storage state shown in FIG. 10A is changed to the storage state in which 1-euro coins and 0.01-euro coins are replaced with each other as shown in FIG. 10D, thereby completing the replacement process.

FIGS. 10A to 10D show an example of the replacement process and do not limit the method for the replacement process. For example, the overflow storage unit 200 may be used for the replacement process. Specifically, all 0.2-euro coins and 1-euro coins are fed out from the upper-right storage unit 150 to the lower transport unit 130b. Then, based on the recognition result by the recognition unit 120, 1-euro coins are stored into the overflow storage unit 200 and 0.2-euro coins are returned to the upper-right storage unit 150. Subsequently, all 0.01-euro coins are fed out from the upper-left storage unit 150 and are stored into the upper-right storage unit 150 without being recognized, whereby the upper-left storage unit 150 is emptied while 0.2-euro coins and 0.01-euro coins are stored in the upper-right storage unit 150. Thereafter, all the coins in the overflow storage unit 200 are fed out, 1-euro coins are stored into the emptied upper-left storage unit 150 and the other coins are returned to the overflow storage unit 200, resulting in the storage state shown in FIG. 10D.

For example, if the upper-left storage unit 150 that was used as a single storage unit can be used as a mixture storage unit and the upper-right storage unit 150 that was used as a mixture storage unit can be used as a single storage unit, 0.2-euro coins are transferred from the upper-right storage unit 150 to the upper-left storage unit 150 shown in FIG. 10A. Specifically, all 0.2-euro coins and 1-euro coins are fed out from the upper-right storage unit 150 being a mixture storage unit, to the lower transport unit 130b. Thereafter, the fed-out coins are recognized one by one, by the recognition unit 120, and 0.2-euro coins are stored into the upper-left storage unit 150 in which 0.01-euro coins are being stored while 1-euro coins are returned to the upper-right storage unit 150. As a result, the upper-left storage unit 150 becomes a mixture storage unit for 0.01-euro coins and 0.2-euro coins, and the upper-right storage unit 150 becomes a single storage unit for 1-euro coins.

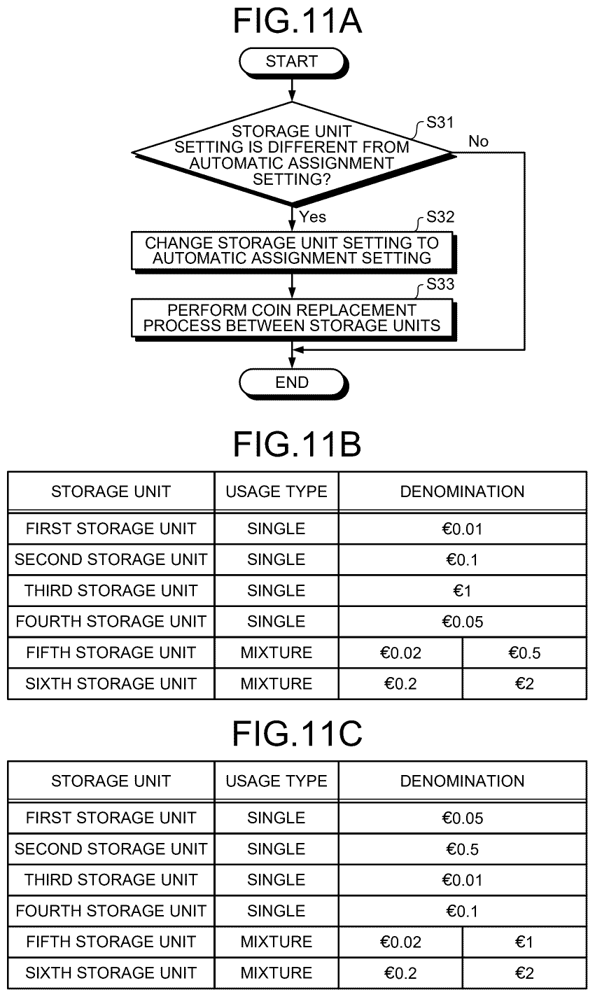

The process for changing the storage unit setting, i.e., the process for replacing the denomination assignment between the denomination assigned to the mixture storage unit and the denomination assigned to the single storage unit, may be performed in other cases. FIGS. 11A to 11C illustrate another example of changing the storage unit setting.

For example, as shown in FIG. 11A, the coin handling apparatus 10 compares the current storage unit setting with automatic assignment setting prepared in advance (step S31). The automatic assignment setting is preferable storage unit setting that has been prepared in advance in the memory 180 of the coin handling apparatus 10. For example, the automatic assignment setting is prepared in advance for each type of currency.

FIG. 11B shows an example of the automatic assignment setting. In the automatic assignment setting shown in FIG. 11B, 0.01 euro, 0.1 euro, and 1 euro, i.e., denominations equivalent to 10 to the power of n (n: integer), are preferentially assigned to single storage units, and denominations, with which the number of coins to be combined when performing substitute dispensing becomes large, are assigned in ascending order to the remaining single storage units. In the example shown in FIG. 11B, after the denominations equivalent to 10 to the power of n are assigned to the single storage units, denominations to be assigned to the remaining single storage units are selected from among 0.02 euro, 0.05 euro, 0.2 euro, 0.5 euro, and 2 euro. When performing substitute dispensing with the coins stored in the single storage units, only two coins are required for the substitute dispensing regarding 0.02 euro, 0.2 euro, and 2 euro, whereas 5 coins are required regarding 0.05-euro and 0.5 euro. For this reason, 0.05 euro and 0.5 euro are preferentially assigned to the single storage units, but since there is only one single storage unit left, the lower-value denomination, 0.05 euro, is preferentially assigned to the single storage unit. For example, if the denominations assigned to the single storage units by the user match the denominations assigned to the single storage units of the automatic assignment setting, the coin handling apparatus 10 determines that there is a match (step S31; No) and ends the process without changing the storage unit setting. Not limited to the case where denomination assignment matches in all the single storage units, the coin handling apparatus 10 may determine that there is a match if some denominations including the lowest denomination among the denominations assigned to a plurality of single storage units of the automatic assignment setting are assigned to the single storage units in the storage unit setting prepared by the user, for example. Specifically, for example, if 0.01 euro and 0.1 euro assigned to the first storage unit and the second storage unit, among the first to fourth storage units in the automatic assignment setting shown in FIG. 11B, are assigned to any single storage units in the storage unit setting prepared by the user, the coin handling apparatus 10 may determine that there is a match even if other settings are different.

As shown in FIG. 11A, if the coin handling apparatus 10 determines that the current storage unit setting is different from the automatic assignment setting (step S31; Yes), the coin handling apparatus 10 determines to change the storage unit setting prepared by the user to the automatic assignment setting. As described above, the coin handling apparatus 10 changes the denomination assignment in the storage unit setting (step S32), and performs the replacement process for replacing the actual coins stored in the storage units based on the changed denomination assignment (step S33).

The automatic assignment setting shown in FIG. 11B is an example and does not limit the contents of the automatic assignment setting. For example, the automatic assignment setting may be configured as shown in FIG. 11C. In the automatic assignment setting shown in FIG. 11C, denominations having the possibility that the number of coins to be combined when performing substitute dispensing becomes large, such as 0.05 euro, 0.5 euro, etc., are preferentially assigned to the single storage units, and denominations equivalent to 10 to the power of n (n: integer) are assigned in ascending order to the remaining single storage units. Thus, by assigning the denominations having the possibility that the number of coins becomes large in the substitute dispensing, to the single storage units, a reduction in dispensing time due to the reduced number of coins to be dispensed can be expected.

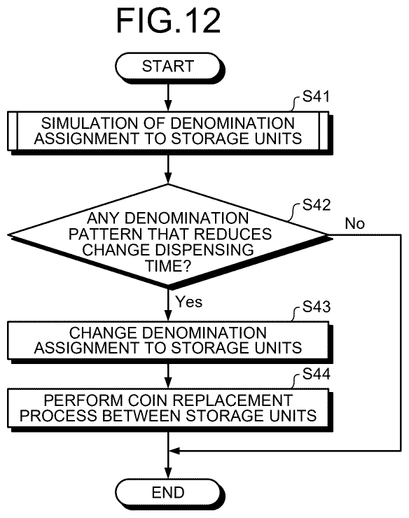

FIG. 12 illustrates still another example in which the coin handling apparatus 10 changes the storage unit setting. In the example shown in FIG. 12, the coin handling apparatus 10 performs a simulation for changing the denominations assigned to the storage units (step S41).

Specifically, the coin handling apparatus 10 calculates the dispensing time required in a case where denomination assignment is changed from the current storage unit setting and all dispensing processes recorded in the dispensing histories are performed based on the changed storage setting. The coin handling apparatus 10 performs simulations to calculate the time required for each dispensing process. The coin handling apparatus 10 performs a simulation for each dispensing process in the case where the denomination assignment is changed, based on the average time required from feeding-out of a coin from a single storage unit to dispensing of the coin from the dispensing unit 140, and on the average time from feeding-out of a coin from a mixture storage unit to dispensing of the coin from the dispensing unit 140 according to the mixing ratio in the mixture storage unit. As for the average time, the coin handling apparatus 10 may actually measure and record the time required for transport from each storage unit 150 to the dispensing unit 140 during the dispensing processes, and may calculate the average time from the recorded actual time by using a statistical method, for example. The average time to be used for the simulation may be prepared in advance in the memory 180. For example, the average time based on the transport distance from each storage unit 150 to the dispensing unit 140, the relationship between the mixing ratio in each mixture storage unit and the feeding time, or the like may be prepared in advance in the memory 180 and used for the simulation. The simulation may be performed using technology such as machine learning or AI (Artificial Intelligence).

For example, simulations are performed so that the setting as to whether each storage unit 150 is used as a mixture storage unit or a single storage unit is not changed, and each of denominations assigned to the mixture storage units is replaced with each of denominations assigned to the single storage units in an exhaustive manner. Simulations including changing the setting as to whether each storage unit 150 is used as a mixture storage unit or a single storage unit, may be performed. Simulations including changing the number of denominations assigned to each mixture storage unit may be performed. For example, simulations may be performed for cases where the number of denominations is changed from two to three for each mixture storage unit. If a simulation execution condition is prepared in advance, the coin handling apparatus 10 performs the simulation based on this condition.

As a result of the simulation, if changing the denomination assignment to the storage units 150, i.e., changing the storage unit setting, does not result in a reduction in the dispensing time (step S42; No), the coin handling apparatus 10 ends the process without changing the storage unit setting. As a result of the simulation, if a denomination assignment pattern that can reduce the dispensing time recorded in the dispensing histories is found (step S42; Yes), the coin handling apparatus 10 changes the denomination assignment to the storage units to the found denomination assignment pattern (step S43), and performs a replacement process for replacing the coins stored in the corresponding storage units.

For example, the storage unit setting may be changed if there is at least one transaction in which the dispensing time is reduced, among the transactions recorded in the dispensing histories. In this case, the storage unit setting may be changed if the dispensing time is reduced by a predetermined percentage or more, such as 10% or more of the dispensing time. Whether or not to change the storage unit setting may be determined by comparing the total time obtained by summing up the times registered under the field of “dispensing time” of the transaction histories, with the total time obtained by summing up the times calculated for the respective transactions in the simulations.

Thus, the coin handling apparatus 10 can perform the simulation to search for denomination assignment that can reduce the dispensing time, compared to the current denomination assignment to the storage units 150. In other words, by performing the simulation, it is possible to search for denomination assignment to the storage units 150 that can reduce the number of times the denomination to be dispensed, which has been determined at the start of the dispensing process, is changed to another denomination before completing the dispensing process. Since the simulations are performed based on the amount of change that were actually needed to be dispensed at the store, it is possible to search for denomination assignment according to the tendency of transactions conducted at the store.

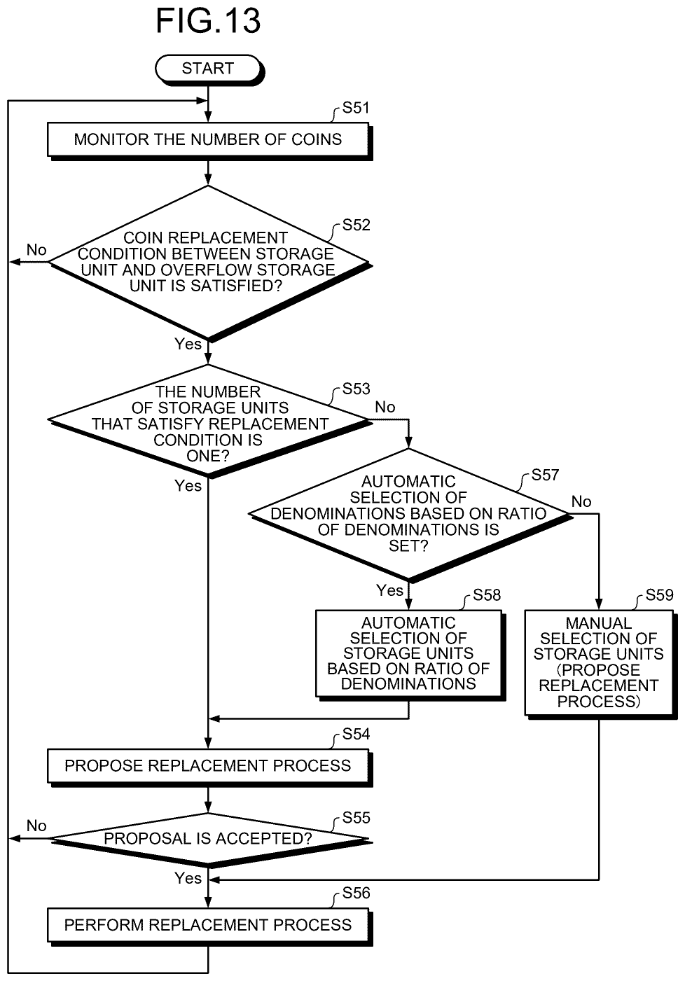

FIG. 13 is a flowchart illustrating yet another example in which the coin handling apparatus 10 changes the storage unit setting. The coin handling apparatus 10 can handle a larger number of coins than the number of coins storable in the storage units 150. For example, the coin handling apparatus 10 can assign denominations to the storage units 150 and store coins by denomination, and can also assign denominations of coins that are not stored in the storage units 150, to the overflow storage unit 200 and store the coins therein, in coin handling such as depositing process.

In the example shown in FIG. 13, the coin handling apparatus 10 compares the number of coins stored in the overflow storage unit 200 with the number of coins stored in a storage unit 150. The coin handling apparatus 10 changes storage unit setting to replace the denomination assigned to the storage unit 150 and the denomination assigned to the overflow storage unit 200 with each other, based on a difference in number, or the ratio of the compared numbers. Then, based on the changed storage unit setting, the coin handling apparatus 10 performs a replacement process for replacing the coins stored in the storage unit 150 and the coins stored in the overflow storage unit 200 with each other.

The overflow storage unit 200 performs only storage of coins and does not perform feeding-out of coins. In the dispensing process, if it is necessary to dispense a coin of a denomination stored only in the overflow storage unit 200, the coin handling apparatus 10 performs substitute dispensing to dispense the amount of this coin by using coins stored by denomination in the storage units 150. To enable such substitute dispensing, coins of the smallest denomination, whose amount is the smallest, is assigned to a storage unit 150 capable of dispensing coins. Even when the coin handling apparatus 10 changes the storage unit setting, coins of the smallest denomination are not stored in the overflow storage unit 200.

For example, when the store opens for the day, the process shown in the flowchart shown in FIG. 13 is started. However, the start timing of the process is not particularly limited. For example, the process may be started when the coin handling apparatus 10 starts operating or when a predetermined menu (e.g., settlement mode) is selected. The process may be started when an instruction to start coin handling in a predetermined mode such as a settlement mode, is given.

When the process shown in FIG. 13 is started, the coin handling apparatus 10 monitors the number of coins stored in a denomination-based storage unit 150 and the number of coins that are not to be dispensed and are stored in the overflow storage unit 200 (step S51). If the number of coins changes in either the storage unit 150 or the overflow storage unit 200, it is determined whether the number of coins satisfies a predetermined replacement condition (step S52). If the replacement condition is not satisfied (step S52; No), monitoring is continued.

The overflow storage unit 200 stores therein coins not to be dispensed, i.e., not to be used for the dispensing process. The coin handling apparatus 10 determines whether the number of coins that are not to be dispensed and are stored in the overflow storage unit 200 is larger than the number of coins that are stored in the storage unit 150 and can be dispensed. The coin handling apparatus 10 determines whether a difference between the number of coins of the denomination that are not to be dispensed and are stored in the overflow storage unit 200, and the number of coins stored in the storage unit 150 is equal to or larger than a predetermined number. When the number of coins of a certain denomination stored in the overflow storage unit 200 exceeds the number of coins stored in any one of the storage units 150 storing coins by denomination, by a predetermined number or more, the coin handling apparatus 10 determines that the replacement condition is satisfied (step S52; Yes).

Next, the coin handling apparatus 10 determines whether the number of storage units 150 that satisfy the replacement condition is one (step S53). If the number of storage units 150 that satisfy the replacement condition is one (step S53; Yes), the coin handling apparatus 10 proposes replacement between the coins of the denomination stored in this storage unit 150 and the coins of the denomination stored in the overflow storage unit 200 (step S54). That is, the coin handling apparatus 10 proposes to perform a replacement process for storing the coins of the denomination that are not to be dispensed and are currently stored in the overflow storage unit 200, in the storage unit 150 that satisfies the replacement condition, and storing the coins currently stored in this storage unit 150 into the overflow storage unit 200.

For example, it is assumed that the coin handling apparatus 10 stores 10-JPY coins into the overflow storage unit 200 as coins not to be dispensed and stores 5-JPY coins into a denomination-based storage unit 150, and a threshold for the number of coins at which the replacement condition is determined to be satisfied is set to 10. In this case, the coin handling apparatus 10 proposes replacement of these coins when the number of 10-JPY coins stored in the overflow storage unit 200 exceeds the number of 5-JPY coins stored in the storage unit 150 by 10 or more.

If there are two or more storage units 150 that satisfy the replacement condition (step S53; No), the coin handling apparatus 10 checks whether a setting to automatically select the denomination to be subjected to the replacement process based on the ratio of the denomination stored in each storage unit 150 to the denomination stored in the overflow storage unit 200 has been prepared (step S57).

If this setting has been prepared (step S57; Yes), the coin handling apparatus 10 calculates the ratio of the denomination stored in each of the storage units 150 that satisfy the replacement condition to the denomination stored in the overflow storage unit 200, and selects coins of the denomination with the smallest ratio (step S58).

For example, it is assumed that the coins that are to be subjected to the replacement process and stored in the overflow storage unit 200, are 5-JPY coins, and the two storage units 150 that satisfy the replacement condition are the first storage unit 150 that stores 10-JPY coins and the second storage unit that stores 50-JPY coins. In this case, the ratio of the denomination of the first storage unit 150 that stores 10-JPY coins to the denomination of the overflow storage unit 200 that stores 5-JPY coins is 2 (=10/5), and the ratio of the denomination of the second storage unit 150 that stores 50-JPY coins to the denomination of the overflow storage unit 200 that stores 5-JPY coins is 10 (=50/5). Therefore, the coin handling apparatus 10 selects the first storage unit 150 with the smaller ratio.

After automatically selecting the denominations, the coin handling apparatus 10 proposes a replacement process between 5-JPY coins in the overflow storage unit 200 and 10-JPY coins in the first storage unit 150 (step S54).

The proposal for the replacement process is performed by displaying information such as the denomination to be subjected to the replacement process on the screen of the operation/display unit 170, and displaying a selection screen that allows the user to select whether or not to perform the replacement process. If the user accepts the proposal and selects to perform the replacement process on the selection screen (step S55; Yes), the coin handling apparatus 10 performs the replacement process (step S56). If the user does not accept the proposal for the replacement process and selects not to perform the replacement process (step S55; No), the replacement process is not performed.

If the setting to automatically select the denomination to be subjected to the replacement process based on the ratio of denominations has not been prepared (step S57; No), a process of allowing the user to select the denomination to be subjected to the replacement process is performed (step S59). The coin handling apparatus 10 proposes the replacement process to the user, and allows the user to select, from among the storage units 150 that satisfy the replacement condition, one storage unit 150 that stores coins of the denomination to be replaced with the coins of the denomination stored in the overflow storage unit 200. For example, a selection screen that allows the user to select one of the storage units 150 is displayed on the operation/display unit 170. The selection screen may allow the user to select not to perform the replacement process.

When the user selects one of the storage units 150 on the selection screen, the coin handling apparatus 10 performs a replacement process for replacing the coins stored in the selected storage unit 150 and the coins stored in the overflow storage unit 200 with each other (step S56).

In the replacement process, all the coins stored in the storage unit 150 and the overflow storage unit 200 subjected to the replacement process are fed out to the lower transport unit 130b and are transported to the feeder 110b. Each coin is recognized by the recognition unit 120 and distributed to the storage unit 150 or the overflow storage unit 200. The coins of the denomination to be replaced, which have been stored in the overflow storage unit 200, are stored in the storage unit 150, and the coins of the other denomination are stored in the overflow storage unit 200.

After completing the replacement process, the process returns to step S51, and monitoring for the number of coins in each storage unit 150 and the overflow storage unit 200 is started again. If the user rejects the proposal for the replacement process (step S55; No), the process returns to step S51, and monitoring for the number of coins in each storage unit 150 and the overflow storage unit 200 is started again. The monitoring may not necessarily be started immediately after completion of the replacement process, and may be started after a preset time has elapsed.

In the above example, the coin handling apparatus 10 monitors the number of coins in each storage unit 150 and the overflow storage unit 200, performs a determination process based on the number of coins, and proposes the replacement process. However, the coin handling apparatus 10 may perform a determination process based on the ratio of the number of coins. Specifically, the coin handling apparatus 10 monitors the ratio of the number of coins of the denomination that are not to be dispensed and are stored in the overflow storage unit 200, to the number of coins of the denomination stored in a storage unit 150. For example, if the threshold for determining that the replacement condition is satisfied is set to 50%, the coin handling apparatus 10 proposes the replacement process when the difference between the number of coins of the denomination stored in the overflow storage unit 200 and the number of coins of the denomination stored in the storage unit 150 becomes 50% or more, that is, when the number of coins stored in the overflow storage unit 200 becomes 150% or more of the number of coins stored in the storage unit 150.

When the coin handling apparatus 10 performs the process shown in FIG. 13, the replacement process between the coins stored in the storage unit 150 and the coins stored in the overflow storage unit 200 is performed at the timing when a predetermined condition is satisfied even during business hours of the store. Thus, it is possible to reduce the number of times the coin handling apparatus 10 enters a suspended state in which the apparatus 10 cannot handle coins, due to a certain denomination of coins being excessively reduced, which causes a coin shortage in the storage unit 150, or a certain denomination of coins being excessively increased, which causes the storage unit 150 to be full of coins.

The coin handling apparatus 10 may not necessarily perform setting for automatically selecting denominations, based on the ratio of denominations. That is, in step S53, if there is more than one storage unit that satisfies the replacement condition (step S53; No), the determination process in step S57 is not performed, the process proceeds to step S59, and the coin handling apparatus 10 may perform a process of allowing the user to select the denomination to be subjected to the replacement process.

In the present embodiment, some of a plurality of denominations of coins to be handled by the coin handling apparatus 10 are assigned to the mixture storage units, but the coin handling apparatus 10 can restrict the denomination assignment to prevent occurrence of a situation in which change cannot be dispensed. For example, the denomination assignment is restricted so that 0.01 euro is assigned to a single storage unit to avoid a situation in which change cannot be dispensed because the lowest denomination, 0.01 euro, is assigned to a mixture storage unit. For example, the denomination assignment may be restricted so that each single storage unit is assigned a denomination, the amount of which cannot be dispensed with a predetermined quantity of money or less (e.g., two or less) set in advance, even by combining money of one or more other denominations. For example, the denomination assignment may be restricted so that each mixture storage unit is assigned a denomination, the amount of which can be dispensed by combining money of denominations assigned to one or more single storage units.

In FIG. 9 to FIG. 12 of the present embodiment, denomination assignment is changed and coin replacement is performed for the denominations assigned to the single storage units and the denominations assigned to the mixture storage units. However, the denomination assignment change and the coin replacement may be performed between the single storage units. The denomination assignment change and the coin replacement may be performed between the mixture storage units. The coin replacement process includes a process for transferring coins of a certain denomination from a certain storage unit to another storage unit.

For example, if the transport time to the dispensing unit 140 varies depending on the position of each single storage unit in the coin handling apparatus 10 and a reduction in time required for the dispensing process can be expected by replacing the denominations assigned to the single storage units, replacement of assigned denominations and replacement of actual coins may be performed between these single storage units.

For example, the coin handling apparatus 10 may record a depositing history including denominations and the number for each denomination of coins stored in each storage unit 150 in the depositing process, in addition to the dispensing history, and may perform, based on the depositing history and the dispensing history, replacement of assigned denominations and replacement of actual coins between a plurality of mixture storage units so that the mixing ratios of a plurality of denominations stored in one mixture storage unit are close to equal. For example, when the difference in mixing ratio between denomination A and denomination B in the first mixture storage unit is large and the difference in mixing ratio between denomination C and denomination D in the second mixture storage unit is also large, a replacement process may be performed between the first mixture storage unit and the second mixture storage unit to replace denomination A and denomination C with each other and replace actual coins of these denominations. By replacing denomination A in the first mixture storage unit and denomination C in the second mixture storage unit with each other, it is expected that the difference in mixing ratio between denomination C and denomination B in the first mixture storage unit is reduced and the difference in mixing ratio between denomination A and denomination D in the second mixture storage unit is also reduced. As to whether such a reduction in the difference in mixing ratio can be expected, a simulation of changing denomination assignment to each storage unit 150 may be performed for the depositing histories and the dispensing histories, in a similar manner to the above-described simulation performed for the dispensing histories, and denomination assignment that brings the percentages of quantities of money of the denominations being stored in a mixture storage unit, close to equal as compared to the current denomination assignment, may be searched for. As for the simulation of changing the denomination assignment to the single storage unit and the mixture storage unit described with reference to FIG. 12, this simulation may be performed including the number of coins deposited and dispensed in the dispensing histories and the depositing histories, i.e., including change in the inventory number in the coin handling apparatus 10. The depositing history and the dispensing history may not necessarily be stored in the memory 180 of the coin handling apparatus 10, and may be stored in an external device communicably connected to the coin handling apparatus 10, such as a server device or a dedicated memory device, for example.

In the present embodiment, any of the storage units 150 is used as a mixture storage unit, but the assignment method is not limited thereto. One denomination of coins may be assigned to and stored in each of the storage units 150, and coins of other denominations to be handled in the coin handling apparatus 10 may be stored in a mixed state into the overflow storage unit 200. Since the denominations assigned to the overflow storage unit 200 are not used for dispensing, if the number of coins stored in the overflow storage unit 200 becomes a predetermined number or more, or when the inventory number of coins assigned to a storage unit 150 becomes less than a predetermined number, the denominations assigned to the overflow storage unit 200 and the storage unit 150 may be changed.

In the present embodiment, dispensing of change has been described as an example, but the target of the above-described processes is not limited to dispensing of change. For example, even in a money handling apparatus that dispenses money equivalent to the amount withdrawn from an account by the customer, efficiency of the dispensing process can be improved by performing the above-described processes. Likewise, even in vending machines, ticket vending machines, etc., efficiency of the dispensing process can be improved by performing the above-described processes. Moreover, each of the examples has been described mainly with coins, but the above-described processes may be performed for banknotes.

A money handling method according to the present disclosure is a method for a money handling apparatus configured to feed out money from a plurality of storage units including a first storage unit storing a plurality of denominations of money in a mixed state, and dispenses the money. The method includes: performing a dispensing process for dispensing money of denominations and the quantity for each denomination corresponding to an amount to be dispensed; recording a dispensing history including information on the denominations and the quantity for each denomination of the money, corresponding to the amount to be dispensed, dispensed in the dispensing process; changing, based on the dispensing history, a denomination assignment to assign a first denomination included in the plurality of denominations assigned to the first storage unit, to another storage unit different from the first storage unit, among the plurality of storage units; and performing a replacement process for transferring money of the first denomination from the first storage unit to the other storage unit, for which the assigned denominations are changed.

In the above configuration, the plurality of storage units may include a second storage unit that stores therein a single denomination of money.

In the above configuration, the method may further include, accumulating based on the dispensing history recorded within a predetermined period, the quantity of dispensed money for each denomination, to compare accumulated quantities. In a case where the quantity accumulated for the first denomination assigned to the first storage unit is larger than the quantity accumulated for the second denomination assigned to the second storage unit, the denomination assignment may be changed between the first storage unit and the second storage unit, and the replacement process may be performed for exchanging the money of the first denomination in the first storage and the money of the second denomination in the second storage unit.

In the above configuration, the method may further include: performing a depositing process to recognized a denomination of money deposited from outside the apparatus and store the money in one of the plurality of storage units corresponding to the denomination; recording a depositing history including information on the denominations and the quantity for each denomination of the money deposited in the depositing process; performing a simulation to change the denominations assigned to the storage units, based on the depositing histories and the dispensing histories recorded within a predetermined period, and to search for a denomination assignment for the storage units by which the quantity of money of each denomination stored in the first storage unit is close to equal, compared to the current denomination assignment; changing, based on a result of the simulation, the denominations assigned to the storage units; and performing a replacement process for exchanging the money among the storage units for which change the assigned denominations have been changed.

In the above configuration, the dispensing history and the depositing history may be stored in a memory of the money handling apparatus.

In the above configuration, the dispensing history and the depositing history may be stored in an external device communicably connected to the money handling apparatus.

In the above configuration, determining whether the denomination assignment needs to be changed may be performed each time the predetermined period elapses.

In the above configuration, the single denomination assigned to the second storage unit may be a denomination whose amount cannot be dispensed by combining pieces of money of one or more other denominations within a predetermined number of pieces of the money.

In the above configuration, the denomination assigned to the first storage unit may be a denomination whose amount can be dispensed by combining pieces of money of one or more denominations each of which is assigned to the second storage unit.

In the above configuration, in the dispensing process after determining a combination of denominations and a quantity for each denomination of the money to dispense the dispensing amount, in a case where a predetermined condition is satisfied before completing the dispensing process, the denomination of the money to be dispensed, from the first storage unit, may be changed to another denomination, the combination may be changed to include the other denomination determined to be dispensed instead of the money from the first storage unit to dispense the dispensing amount, and the dispensing process may be continued by dispensing money based on the changed combination.

In the above configuration, in a case where a ratio of the quantity of money to be dispensed from the first storage unit to the quantity of all money stored in the first storage unit is smaller than a predetermined threshold, the denomination of the money to be dispensed from the first storage unit may be changed to another denomination.

In the above configuration, the dispensing history may include a first combination indicating denominations and the quantity for each denomination of money dispensed in the dispensing process. In a case where the denomination of money to be dispensed is changed before completing the dispensing process, the dispensing history may further include a second combination indicating denominations and the quantity for each denomination before the change.

In the above configuration, the accumulating the quantity of money for each denomination to compare the accumulated quantities may be performed using the second combination for the dispensing process for which the second combination is recorded, and the accumulating may be performed using the first combination for the dispensing process for which the second combination is not recorded.

In the above configuration, the method may further include performing a simulation to change the denominations assigned to the first storage unit and the second storage unit, based on the dispensing histories recorded within a predetermined period, and to search for a denomination assignment for the first storage unit and the second storage unit by which the number of times the denomination is changed before completing the dispensing process is decreased, compared to the current denomination assignment; changing, based on a result of the simulation, the denominations assigned to the first storage unit and the second storage unit; and performing the replacement process for exchanging the money in the first storage unit and the money in the second storage unit.

In the above configuration, after starting feeding-out of money from the mixture storage unit in which money determined to be dispensed is stored, if a predetermined threshold time has elapsed without feeding out the money to be dispensed, it may be determined that the predetermined condition is satisfied and the denomination of the money to be dispensed may be changed to another denomination.

In the above configuration, after starting feeding-out of money from the mixture storage unit in which money determined to be dispensed is stored, if the money to be dispensed was not fed out although a predetermined threshold number of pieces of money have been fed out, it may be determined that the predetermined condition is satisfied and the denomination of the money to be dispensed may be changed to another denomination.

In the above configuration, the plurality of storage units may include a mixture storage unit that performs storage of coins and does not perform feeding-out of coins during the dispensing process. In this case, a detachable interface cassette for money replenishment or collection may be used as the mixture storage unit.

A money handling apparatus according to the present disclosure includes: a plurality of storage units including a first storage unit in which a plurality of denominations of money are stored in a mixed state; a recognition unit configured to recognize a denomination of money fed out from each storage unit; a dispensing unit configured to discharge the money recognized by the recognition unit to outside the apparatus; and a transport unit configured to transport money between the storage units, the recognition unit, and the dispensing unit. The money handling apparatus is configured to record a dispensing history including information on denominations and a quantity for each denomination dispensed in a dispensing process for dispensing a dispensing amount to be dispensed; change, based on the dispensing history, a denomination assignment to assign a first denomination included in the plurality of denominations assigned to the first storage unit, to another storage unit different from the first storage unit among the plurality of storage units; and perform a replacement process for transferring money of the first denomination from the first storage unit to the other storage unit, for which the assigned denominations are changed. The money handling apparatus may further include a control circuitry that controls the storage units, the recognition units, and the transport unit. When performing the replacement process, the control circuitry may control feeding-out of money from the storage units, recognition of money by the recognition unit, transport of money by the transport unit, storage of money in the storage units, and the like.

According to the money handling apparatus and the money handling method of the present disclosure, a dispensing process can be efficiently performed even when a plurality of denominations are assigned to at least one storage unit included in the money handling apparatus and money is stored in a mixed state therein.

As described above, in the money handling apparatus, each of a plurality of storage units can be used as a single storage unit or a mixture storage unit. In the dispensing process, the money handling apparatus can automatically change the combination of money to be dispensed, according to need, to avoid the situation in which money to be dispensed from the mixture storage unit is not readily fed out and it takes a long time until the dispensing process is completed. The money handling apparatus can record information regarding the dispensing process, change denomination assignment between a plurality of storage units based on the contents of the dispensing processes in the past, and exchange actual money between the storage units based on the changed denomination assignment. Thus, the dispensing process can be efficiently performed while avoiding the situation in which it takes a long time until dispensing is completed because a plurality of denominations are assigned to a storage unit.

1. A money handling method for a money handling apparatus configured to feed out money from a plurality of storage units including a first storage unit storing a plurality of denominations of money in a mixed state, and dispenses the money, the method comprising:
performing a dispensing process for dispensing money of denominations and a quantity for each denomination corresponding to a dispensing amount to be dispensed;
recording a dispensing history including information on the denominations and the quantity for each denomination of the money, corresponding to the dispensing amount, dispensed in the dispensing process;
changing, based on the dispensing history, a denomination assignment to assign a first denomination included in the plurality of denominations assigned to the first storage unit, to another storage unit different from the first storage unit among the plurality of storage units; and
performing a replacement process for transferring money of the first denomination from the first storage unit to the other storage unit, for which the assigned denominations are changed.

2. The money handling method according to claim 1, wherein
the plurality of storage units includes a second storage unit that stores therein a single denomination of money.

3. The money handling method according to claim 2, further comprising,
accumulating, based on the dispensing histories recorded within a predetermined period, the quantity of dispensed money for each denomination, to compare accumulated quantities, wherein
in a case where the quantity accumulated for the first denomination assigned to the first storage unit is larger than the quantity accumulated for the second denomination assigned to the second storage unit,
the denomination assignment is changed between the first storage unit and the second storage unit, and
the replacement process is performed for exchanging the money of the first denomination in the first storage unit and the money of the second denomination in the second storage unit.

4. The money handling method according to claim 2, further comprising:
performing a depositing process to recognize a denomination of money deposited from outside the apparatus and store the money in one of the plurality of storage units corresponding to the denomination;
recording a depositing history including information on the denominations and the quantity for each denomination of the money deposited in the depositing process;
performing a simulation to change the denominations assigned to the storage units, based on the depositing histories and the dispensing histories recorded within a predetermined period, and to search for a denomination assignment for the storage units by which the quantity of money of each denomination stored in the first storage unit is close to equal, compared to the current denomination assignment;
changing, based on a result of the simulation, the denominations assigned to the storage units; and
performing a replacement process for exchanging the money among the storage units for which the assigned denominations have been changed.

5. The money handling method according to claim 4, wherein
the dispensing history and the depositing history are stored in a memory of the money handling apparatus.

6. The money handling method according to claim 4, wherein
the dispensing history and the depositing history are stored in an external device communicably connected to the money handling apparatus.

7. The money handling method according to claim 3, wherein
determining whether the denomination assignment needs to be changed is performed each time the predetermined period elapses.

8. The money handling method according to claim 2, wherein
the single denomination assigned to the second storage unit is a denomination whose amount cannot be dispensed by combining pieces of money of one or more other denominations within a predetermined number of pieces of the money.

9. The money handling method according to claim 2, wherein
the denomination assigned to the first storage unit is a denomination whose amount can be dispensed by combining pieces of money of one or more other denominations each of which is assigned to the second storage unit.

10. The money handling method according to claim 1, wherein
in the dispensing process after determining a combination of denominations and a quantity for each denomination of the money to dispense the dispensing amount,
in a case where a predetermined condition is satisfied before completing the dispensing process,
the denomination of the money to be dispensed from the first storage unit is changed to another denomination,
the combination is changed to include the other denomination determined to be dispensed instead of the money from the first storage unit to dispense the dispensing amount, and
the dispensing process is continued by dispensing money based on the changed combination.

11. The money handling method according to claim 10, wherein
in a case where a ratio of the quantity of money to be dispensed from the first storage unit to the quantity of all money stored in the first storage unit is smaller than a predetermined threshold, the denomination of the money to be dispensed from the first storage unit is changed to another denomination.

12. The money handling method according to claim 10, wherein
the dispensing history includes a first combination indicating denominations and the quantity for each denomination of money dispensed in the dispensing process, and
in a case where a denomination of money to be dispensed is changed before completing the dispensing process, the dispensing history further includes a second combination indicating denominations and the quantity for each denomination before the change.

13. The money handling method according to claim 12, wherein
the accumulating the quantity of money for each denomination to compare the accumulated quantities is performed using the second combination for the dispensing process for which the second combination is recorded, and
the accumulating is performed using the first combination for the dispensing process for which the second combination is not recorded.

14. The money handling method according to claim 2, further comprising:
performing a simulation to change the denominations assigned to the first storage unit and the second storage unit, based on the dispensing histories recorded within a predetermined period, and to search for a denomination assignment for the first storage unit and the second storage unit by which the number of times the denomination is changed before completing the dispensing process is decreased, compared to the current denomination assignment;
changing, based on a result of the simulation, the denominations assigned to the first storage unit and the second storage unit; and
performing the replacement process for exchanging the money in the first storage unit and the money in the second storage unit.

15. A money handling apparatus comprising:
a plurality of storage units including a first storage unit in which a plurality of denominations of money are stored in a mixed state;
a recognition unit configured to recognize a denomination of money fed out from each storage unit;
a dispensing unit configured to discharge the money recognized by the recognition unit to outside the apparatus; and
a transport unit configured to transport money between the storage units, the recognition unit, and the dispensing unit, wherein
the money handling apparatus is configured to
record a dispensing history including information on denominations and a quantity for each denomination dispensed in a dispensing process for dispensing a dispensing amount to be dispensed;
change, based on the dispensing history, a denomination assignment to assign a first denomination included in the plurality of denominations assigned to the first storage unit, to another storage unit different from the first storage unit among the plurality of storage units; and
perform a replacement process for transferring money of the first denomination from the first storage unit to the other storage unit, for which the assigned denominations are changed.
